(19) United States
(12) Patent Application Publication
(10) Pub. No.: US 2025/0070471 A1
(43) Pub. Date: Feb. 27, 2025

(54) PATCH ANTENNA AND ANTENNA DEVICE

(71) Applicant: YOKOWO CO., LTD., Tokyo (JP)

(72) Inventors: Hiroto IEDA, Tomioka-Shi, Gunma (JP); Kazuhiro KOWAITA, Tomioka-Shi, Gunma (JP)

(73) Assignee: YOKOWO CO., LTD., Tokyo (JP)

(21) Appl. No.: 18/724,139

(22) PCT Filed: Dec. 26, 2022
(86) PCT No.: PCT/JP2022/048037

§ 371 Date: Jun. 25, 2024

(30) Foreign Application Priority Data
Dec. 27, 2021 (JP) 2021-212202

(51) Int. Cl. H01Q 9/04; H01Q 1/32; H01Q 1/48

(52) U.S. Cl. CPC H01Q 9/0414; H01Q 1/32; H01Q 1/48

(57) ABSTRACT

A patch antenna includes a radiating element; a dielectric located on one surface side of the radiating element; and a first metal body located on a side opposite to the one surface side of the radiating element, the first metal body being located so as to correspond to a wave source of the radiating element. The radiating element is located between the dielectric and the first metal body, and the first metal body and a center of the radiating element are non-overlapping in plan view, the plan view being a view in a direction perpendicular to the one surface of the radiating element.

### TECHNICAL FIELD

The present disclosure relates to a patch antenna and an antenna device.

### BACKGROUND ART

There are patch antennas as planar antennas that include a radiating element at one surface of a dielectric (for example, PTL 1).

### CITATION LIST

### Patent Literature

[PTL 1] Japanese Unexamined Patent Publication No. 2017-191961

### SUMMARY OF INVENTION

### Technical Problem

Depending on the configuration of a patch antenna, the axial ratio of at least part of an elevation angle from a low elevation angle to a high elevation angle may deteriorate. Thus, in order to improve the axial ratio, a metal body may be provided above a radiating element.

However, if the metal body is provided above the radiating element, the parasitic capacitance generated between the radiating element and the metal body increases, and the impedance of the patch antenna changes. As a result, in order to operate the patch antenna with a desired frequency band, for example, the size of the radiating element needs to be increased or reduced.

The present disclosure is directed to, for example, suppression of change in input impedance of a patch antenna. The present disclosure is directed also to others, which will become apparent from the description of this specification.

### Solution to Problem

An aspect of the present disclosure is a patch antenna comprising: a radiating element; a dielectric located on one surface side of the radiating element; and a first metal body located on a side opposite to the one surface side of the radiating element, the first metal body being located so as to correspond to a wave source of the radiating element, wherein the radiating element is located between the dielectric and the first metal body, and the first metal body and a center of the radiating element are non-overlapping in plan view, the plan view being a view in a direction perpendicular to the one surface of the radiating element.

Another aspect of the present disclosure is an antenna device comprising: a case; a base and the case form a housing space; a patch antenna housed in the housing space, the patch antenna supporting radio waves in a first frequency band; and at least one antenna that supports radio waves in a second frequency band different from the first frequency band, wherein the patch antenna includes a dielectric, a radiating element located on an upper surface side of the dielectric; and a first metal body located above a wave source of the radiating element, wherein the first metal body and a center of the radiating element are non-overlapping in a plan view, the plan view being a view in a direction perpendicular to an upper surface of the radiating element, and the first metal body and the radiating element are electrically coupled.

According to an aspect of the present disclosure, it is to suppress change in input impedance of a patch antenna.

### BRIEF DESCRIPTION OF DRAWINGS

FIG. 1 is a diagram illustrating a configuration of a vehicular antenna device 10.

FIG. 2A is a diagram for describing a patch antenna.

FIG. 2B is a diagram for describing a patch antenna.

FIG. 2C is a diagram for describing a patch antenna.

FIG. 3 is a diagram illustrating a configuration of a vehicular antenna device 11.

FIG. 4 is an exploded perspective view of a patch antenna 35.

FIG. 5 is a cross-sectional perspective view of a patch antenna 35.

FIG. 6 is a diagram illustrating an example of the positional relationship between a radiating element 41 and a metal body 46.

FIG. 7 is a diagram illustrating the characteristics of a patch antenna 30.

FIG. 8 is a diagram illustrating the characteristics of a patch antenna 35.

FIG. 9A is a diagram illustrating an example of another embodiment of a radiating element and a metal body.

FIG. 9B is a diagram illustrating an example of another embodiment of a radiating element and a metal body.

FIG. 10 is a diagram illustrating an example of another embodiment of a radiating element and a metal body.

FIG. 11 is a diagram illustrating a configuration of a vehicular antenna device 12.

FIG. 12 is a diagram illustrating a configuration of a vehicular antenna device 13.

FIG. 13 is a perspective view of a patch antenna 127.

FIG. 14 is an exploded perspective view of a patch antenna 127.

FIG. 15 is a diagram illustrating the characteristics of a patch antenna 125.

FIG. 16 is a diagram illustrating the characteristics of a patch antenna 127.

FIG. 17 is a diagram illustrating a configuration of a vehicular antenna device 14.

FIG. 18 is a diagram illustrating a configuration of a vehicular antenna device 15.

FIG. 19 is a diagram illustrating a configuration of a vehicular antenna device 16.

FIG. 20A is a diagram illustrating an example of a main body portion 300 of a patch antenna.

FIG. 20B is diagram illustrating an example of a main body portion 300 of a patch antenna.

FIG. 21A is a schematic view illustrating the relationship between a patch antenna and a ground member.

FIG. 21B is a schematic view illustrating the relationship between a patch antenna and a ground member.

FIG. 21C is a schematic view illustrating the relationship between a patch antenna and a ground member.

FIG. 21D is a schematic view illustrating the relationship between a patch antenna and a ground member.

FIG. 21E is a schematic view illustrating the relationship between a patch antenna and a ground member.

FIG. 22 is a perspective view of a patch antenna 502.

FIG. 23 is a schematic view illustrating the electric lines of force around a patch antenna 502.

FIG. 24A is a schematic view for describing an arrangement of feed lines 510 and 511.

FIG. 24B is a schematic view for describing an arrangement of feed lines 510 and 511.

FIG. 24C is a schematic view for describing an arrangement of feed lines 510 and 511.

FIG. 25 is a cross-sectional perspective view taken along a line E-E of FIG. 22.

FIG. 26A is a diagram for describing an example of a metal base 500 and a patch antenna 502.

FIG. 26B is diagram for describing the relationship between a patch antenna 502 and a shield member.

FIG. 27 is a schematic view illustrating the electric lines of force around a patch antenna 502.

FIG. 28 is a diagram illustrating a configuration of a vehicular antenna device 17 (18, 19).

FIG. 29 is a perspective view of a patch antenna 600.

FIG. 30 is an exploded perspective view of a patch antenna 600.

FIG. 31 is a perspective view of a patch antenna 601.

FIG. 32 is an exploded perspective view of a patch antenna 601.

FIG. 33 is a perspective view of a patch antenna 602.

FIG. 34 is an exploded perspective view of a patch antenna 602.

### DESCRIPTION OF EMBODIMENTS

At least the following matters will become apparent from the description of the present specification and the accompanying drawings.

With reference to the drawings, preferred embodiments of the present disclosure will be described below. The same or equivalent components, members, and the like illustrated in the drawings are denoted by the same reference numerals, and redundant description thereof is omitted as appropriate.

### Vehicular Antenna Device 10

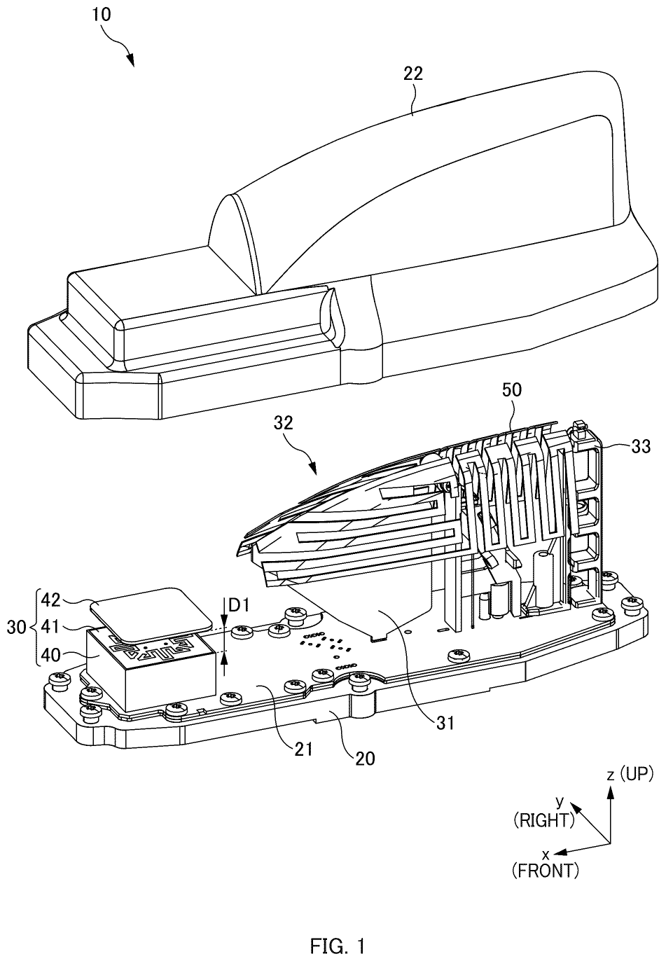

FIG. 1 is a diagram illustrating a configuration of a vehicular antenna device 10. The vehicular antenna device 10 is a device to be attached to a roof at the upper surface of a vehicle (not illustrated), and includes an antenna base 20, a substrate 21, a case 22, a patch antenna 30, and antennas 31 to 33. Here, the “vehicle” refers to a wheeled vehicle, such as a car, construction equipment, or the like.

In FIG. 1, an x direction is a front-rear direction of the vehicle to which the vehicular antenna device 10 is to be attached, a y direction is a left-right direction perpendicular to the x direction, and a z direction is a vertical direction perpendicular to the x direction and the y direction. Further, a +x direction is a direction from a driver seat of the vehicle toward a front side, a +y direction is a direction therefrom toward a right side, and a +z direction is a zenith direction (upward) therefrom. In the following description, the front-rear, left-right, and up-down directions of the vehicular antenna device 10 are the same as the front-rear, left-right, and up-down directions of the vehicle, in an embodiment of the present disclosure.

The antenna base 20 is a plate-shaped member forming the bottom surface of the vehicular antenna device 10. The antenna base 20 is an insulating base made of resin including a metal base (not illustrated) that functions as a ground for the vehicular antenna device 10. The antenna base 20 may be formed of only a metal base, for example.

The antenna base 20 is an insulating base including a metal base, but it is not limited thereto. For example, the antenna base 20 may be formed of only a metal base or a metal plate, or may be attached with another member such as an insulating base, a metal plate, or the like. Further, the antenna base 20 may include an insulating base and a metal plate, or may include an insulating base, a metal base, and a metal plate. Alternatively, a structure may be employed in which a waterproof pad is used to surround a metal base without using an insulating base.

The substrate 21 is a circuit board to which a patch antenna 30 and/or the like, which will be described later, are mounted, and is provided to the front surface of the antenna base 20. Four antennas that are the patch antenna 30 and the antennas 31 to 33 are mounted at the substrate 21.

The case 22 is a member (so-called radome) that forms, together with the antenna base 20, a housing space in which the patch antenna 30 and the like are housed by covering the antenna base 20. The case 22 is a case made of a synthetic resin (for example, ABS resin) that allows electromagnetic waves to pass therethrough, and has a shark-fin shape whose height is low at the front and increases toward the rear.

The patch antenna 30 is, for example, an antenna to receive radio waves in an L1 band (center frequency: 1575.42 MHz) and an L5 band (center frequency: 1176.45 MHz) for a global positioning satellite system (GNSS: Global Navigation Satellite System). The patch antenna 30 includes a dielectric 40 made of a dielectric material such as ceramic or the like, a radiating element 41 that supports radio waves in the L1 band and the L5 band, and a metal body 42. Details of the metal body 42 will be described later.

The antenna 31 is an antenna that supports radio waves for telematics such as Long Term Evolution (LTE). The antenna 31 supports radio waves in the 700 MHz to 5.0 GHz band, for example.

The antenna 32 is, for example, an antenna to receive radio waves for AM/FM radio. Specifically, the antenna 32 receives radio waves of 522 kHz to 1710 kHz for the AM broadcast and radio waves of 76 MHz to 108 MHz for the FM broadcast, for example. The antenna 32 includes a capacitive loading element 50 and a helical element (not illustrated).

The antenna 33 is an antenna that supports radio waves for Vehicle-to-Everything (V2X), for example. Although the vehicular antenna device 10 includes the above-described four antennas, the present disclosure is not limited thereto. For example, it does not have to include any one of the antennas 31 to 33. Further, the vehicular antenna device 10 may further include an antenna.

### Details of Metal Body 42

The metal body 42 is a substantially square top plate (or top capacitive plate) provided above the radiating element 41 in order to improve the axial ratio of the patch antenna 30. In an embodiment of the present disclosure, the metal body 42 has a shape in which one side of the substantially square metal body 42 is larger than one side of the substantially square radiating element 41.

Here, the term “metal body” indicates one formed by processing a metal member, and includes, for example, not only a plate-shaped metal member such as a metal plate and the like but also a metal member in a three dimensional shape other than the plate shape. Further, when the metal body is used as a part of an antenna, for example, the metal body may be referred to as a parasitic element. Here, the term “substantial square” includes a shape in which at least a part of corners is cut away obliquely relative to a side and a shape in which a cut (recessed portion) or a protrusion (protruding portion) is provided to a part of a side.

Here, the metal body 42 is held by a holding member (not illustrated) such that the geometric center of the metal body 42 and the geometric center of the radiating element 41 are aligned with each other in plan view when viewed perpendicularly (in the +z direction) from the front surface of the radiating element 41.

Hereinafter, unless otherwise specified, the term “geometric center” of the metal body 42 or the radiating element 41 will be simply referred to as the center. Further, unless otherwise specified, the phrase “in plan view” refers to a plane when viewed in the +z direction perpendicular to the front surface of the radiating element 41 (xy plane in an embodiment of the present disclosure).

### Parasitic Capacitance of Patch Antenna 30

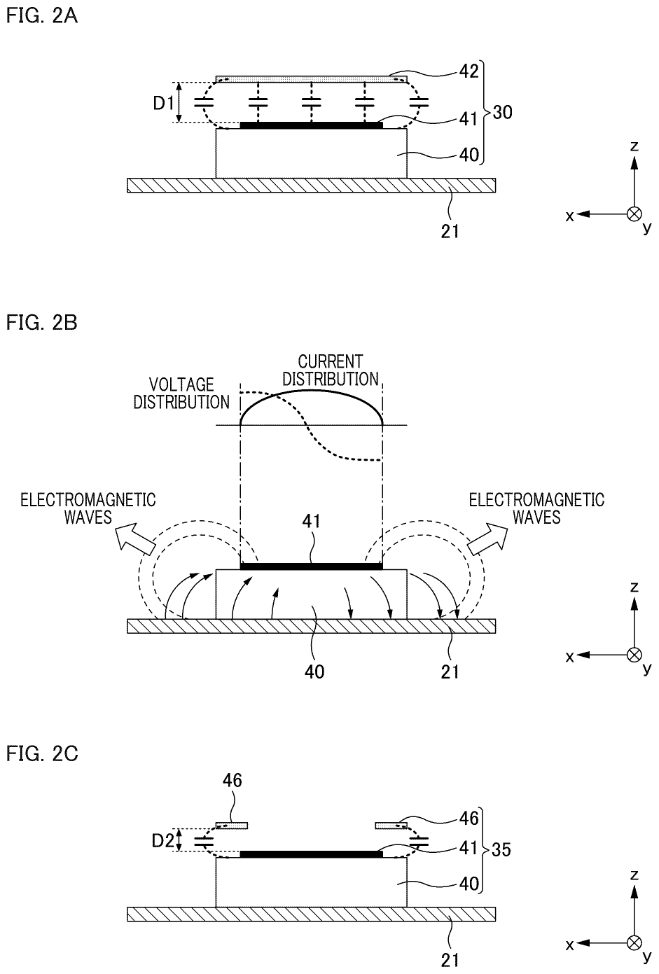

FIG. 2A is a schematic diagram for describing parasitic capacitance in the patch antenna 30. In the patch antenna 30, for example, the area in which the metal body 42 and the radiating element 41 face each other is large, and thus a relatively large parasitic capacitance occurs between the metal body 42 and the radiating element 41.

Further, for example, when the distance DI between the front surface of the radiating element 41 and the back surface of the metal body 42 is reduced in order to adjust the axial ratio of the patch antenna 30, the parasitic capacitance between the metal body 42, and the dielectric 40 and radiating element 41 increases as well. As a result, the impedance of the patch antenna 30 also changes significantly, and thus in order to operate the patch antenna 30 in a desired frequency band, for example, the size of the radiating element 41 needs to increase.

Accordingly, in order to appropriately operate the patch antenna 30 illustrated in FIG. 1 in a desired frequency band, for example, the size of the patch antenna 30 may increase.

### Wave Source of Patch Antenna

In a typical patch antenna including the dielectric 40 and the radiating element 41 as illustrated in FIG. 2B, the current is maximum near the center of the radiating element 41 and the voltage amplitude is maximum at the end part of the outer edge of the radiating element 41 (hereinafter, may be simply referred to as the end part).

As a result, as schematically illustrated in FIG. 2B, the electric lines of force generated between the end part of the radiating element 41 and the substrate 21 increase, and the end part of the radiating element 41 results in a wave source from which electromagnetic waves (hereinafter simply referred to as radio waves) are radiated. Here, the “wave source” is a part where radio waves are radiated and the voltage amplitude is large in the radiating element.

In general, when adjusting the axial ratio of a patch antenna, it is preferable to provide a top plate at a position corresponding to the wave source (for example, at a position at which the intensity of radio waves radiated from the wave source is high). Thus, in a patch antenna 35 (described later) according to an embodiment of the present disclosure, a metal body 46 is arranged above the wave source, as illustrated in FIG. 2C, for example. Although details will be described later, the shape of the metal body 46 is a surrounding shape that surrounds the center of the radiating element 41 in plan view. Thus, the use of the patch antenna 35 as such can suppress the influence of the parasitic capacitance.

### Vehicular Antenna Device 11 (First Embodiment)

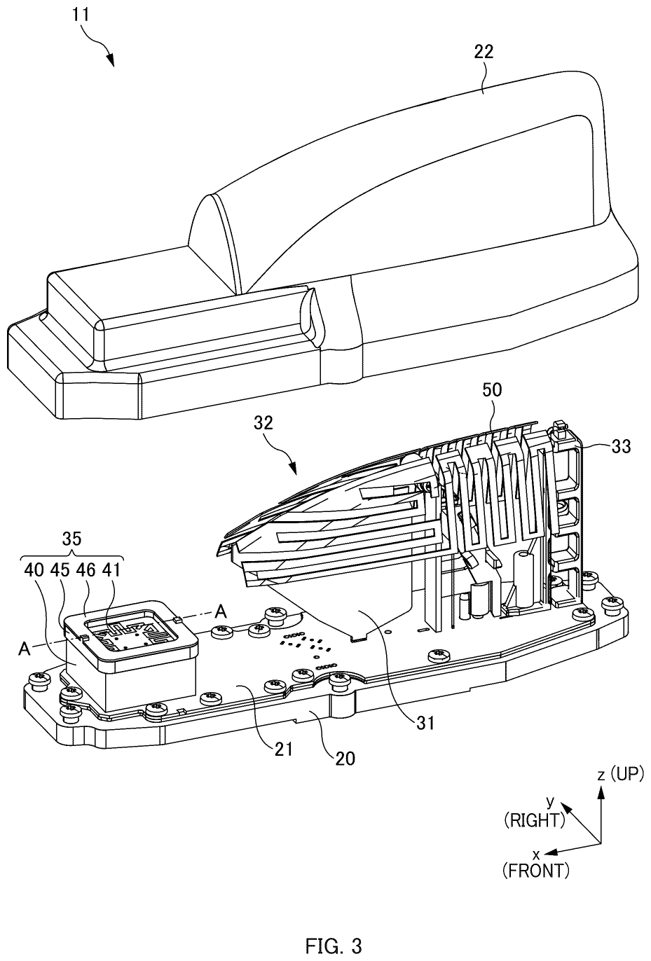

FIG. 3 is a diagram illustrating a configuration of the vehicular antenna device 11 that includes the patch antenna 35 of an embodiment of the present disclosure. The vehicular antenna device 11 includes the antenna base 20, the substrate 21, the case 22, the antennas 31 to 33, and the patch antenna 35.

The vehicular antenna device 10 and the vehicular antenna device 11 have the same configuration except for the patch antenna 35, and thus details of the patch antenna 35 will be described here.

### Derails of Patch Antenna 35

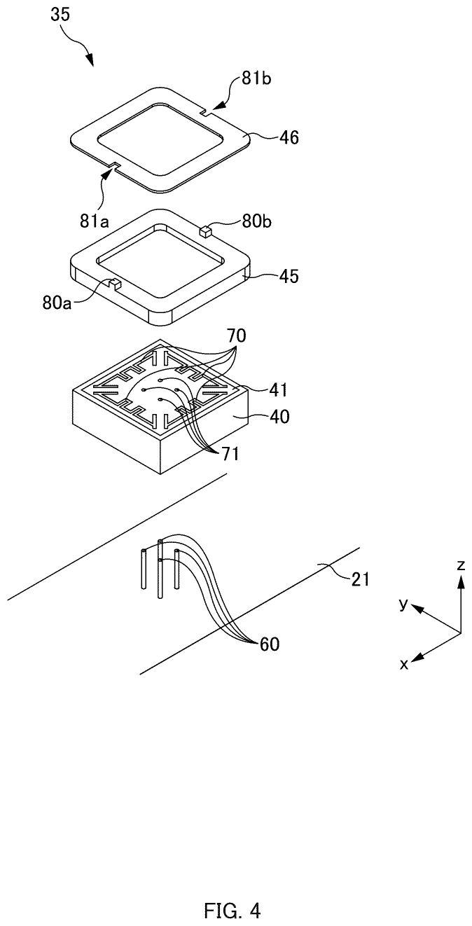

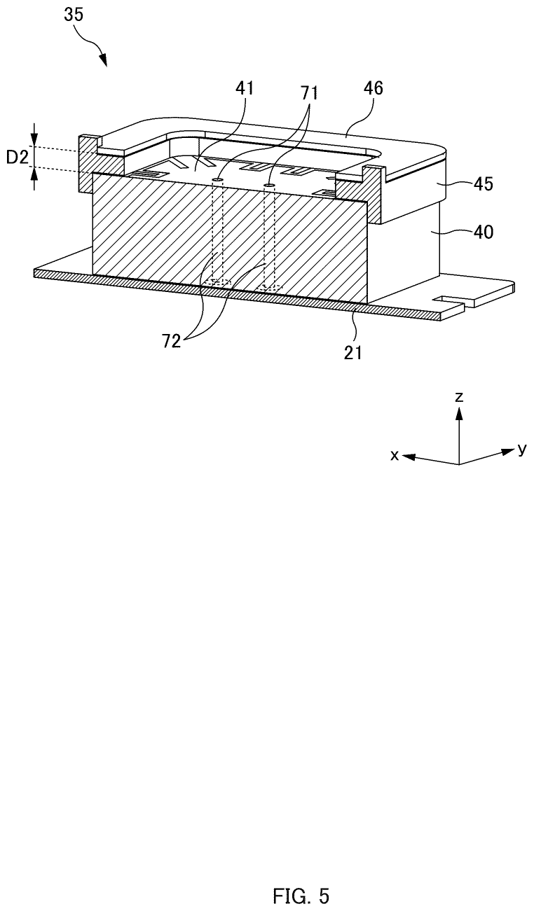

The patch antenna 35 is, as with the patch antenna 30, an antenna to receive radio waves in the L1 band and L5 band for GNSS. The patch antenna 35 includes the dielectric 40, the radiating element 41, a holding member 45, and the metal body 46, as illustrated in FIGS. 4 and 5. Here, FIG. 4 is an exploded perspective view of the patch antenna 35, and FIG. 5 is a cross-sectional perspective view of the patch antenna 35 taken along a line A-A of FIG. 3.

The dielectric 40 is made of a dielectric material such as ceramic or the like, and is a substantially square box-shaped member in plan view of the xy plane when viewed in the +z direction. In an embodiment of the present disclosure, as illustrated in FIG. 5, a through-hole 72 extending through the dielectric 40 is formed. In FIG. 5, only two through-holes 72 are illustrated, however, in actuality, four through-holes 72 are formed in the dielectric 40 such that four feed lines 60 are connected to four feeding points 71 of the radiating element 41, respectively.

A conductor (not illustrated) that functions as a ground conductor film (or ground conductor plate) is formed on the back surface of the dielectric 40, and the ground conductor film is attached to the ground (not illustrated) of the substrate 21 with adhesive or double-sided tape, for example. Although not illustrated, for convenience, the ground formed at the substrate 21 and the metal base (not illustrated) of the antenna base 20 are electrically connected and function as a ground for the vehicular antenna device 11.

Further, the conductive radiating element 41 in a shape of a substantial square is formed at the front surface of the dielectric 40. The radiating element 41 is an element that supports radio waves in multiple frequency bands (for example, the L1 and L5 bands), and includes and four slots 70 respectively provided at positions corresponding to sides thereof, and four feeding points 71.

Here, although the slots 70 are formed in the radiating element 41, the slots 70 may not be provided. Further, the radiating element 41 includes the four feeding points 71, but is not limited thereto, and may include, for example, one or two feeding points. Further, the radiating element 41 may be in a shape of a substantial rectangle with different lengths and widths.

Here, as with the substantial square, the term “substantial rectangle” also includes a shape in which a corner thereof is cut away obliquely relative to a side, for example. Further, in an embodiment of the present disclosure, the substantial square and the substantial rectangle are collectively referred to as a substantial quadrangle as appropriate.

The holding member 45 made of resin is provided at the front surface of the dielectric 40 so as to surround the radiating element 41. The holding member 45 is substantially square frame-shaped member that holds the metal body 46, and has an opening around the geometric center (the center) of the holding member 45. However, the holding member 45 is not limited to the frame-shaped member. For example, the holding member 45 may have a structure that covers the radiating element 41 without having an opening, or may have a structure in which multiple columnar members are arranged along the edge part or outer edge part of the dielectric 40.

Protruding portions 80a and 80b extending in the z-axis direction are respectively formed near the centers of two sides, parallel to the y-axis, of the front surface of the holding member 45. Each of the protruding portions 80a and 80b is, for example, a substantially rectangular parallelepiped-shaped protrusion formed to determine the position of the metal body 46 with respect to the holding member 45.

Here, the term “the center of a side” indicates, for example, a position at which the side on the +x side (or the side on the −x side), parallel to the y axis, of the front surface of the holding member 45 intersects with the axis in the x direction passing through the geometric center (hereinafter, simply referred to as “the center”) of the holding member 45.

The metal body 46 is a top plate to adjust the axial ratio of the patch antenna 35. The metal body 46 has a surrounding shape that surrounds the center of the radiating element 41 in plan view when the metal body 46 is arranged at the holding member 45, and is integrally formed.

The metal body 46 in an embodiment of the present disclosure has a substantially square frame-shape with an opening formed around the geometric center (the center) of the metal body 46, as in the holding member 45, which is a substantially square frame-shaped member. Although details will be described later, the shape of the metal body 46 is not limited to the above-described shape, as long as the axial ratio of the patch antenna 35 can be adjusted while the parasitic capacitance of the patch antenna 35 is suppressed.

In the metal body 46, recessed portions 81a and 81b are formed near the center of a side on the +x side and the center of a side on the −x side, which are parallel to the y-axis. In an embodiment of the present disclosure, the metal body 46 is arranged at the front surface of the holding member 45 in a state where the protruding portions 80a and 80b of the holding member 45 are fitted in the recessed portions 81a and 81b of the metal body 46, respectively.

In an embodiment of the present disclosure, when the holding member 45 and the metal body 46 are stacked on the dielectric 40, the metal body 46 is held such that the center of the dielectric 40 and the center of the opening formed in the metal body 46 are aligned with each other in plan view. Although the center of the dielectric 40 and the center of the opening of the metal body 46 are arranged so as to be aligned with each other in an embodiment of the present disclosure, it is enough for the center of the dielectric 40 to lie within the opening of the metal body 46, and the center of the dielectric body 40 and the center of the metal body 46 do not have to be aligned with each other.

In the patch antenna 35, the center of the substantially square radiating element 41 and the center of the substantially square metal body 46 are substantially aligned with each other as such, thereby being able to further improve the axial ratio. Further, in such a configuration, the patch antenna 35 can be downsized more than the case where the center of the radiating element 41 and the center of the metal body 46 are out of alignment, for example.

### Positional Relationship Between Radiating Element 41 and Metal Body 46

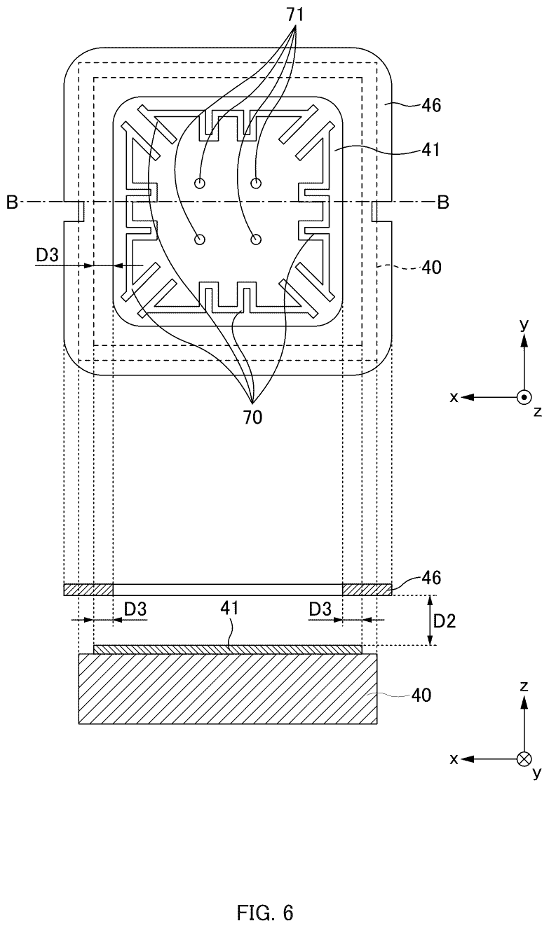

FIG. 6 is a schematic diagram illustrating the positional relationship between the radiating element 41 and the metal body 46. The upper part of FIG. 6 is a plan view of the radiating element 41 and the metal body 46, and the lower part of FIG. 6 is a sectional view taken along a line B-B. In an embodiment of the present disclosure, a distance D2 is defined a distance from the front surface of the radiating element 41 to the back surface of the metal body 46. Further, a distance D3 is defined as a distance between the outer edge of the radiating element 41 and the inner edge of the metal body 46 in plan view.

### Distance D2

Since the metal body 46 is a member to adjust the axial ratio of the patch antenna 35, and in an embodiment of the present disclosure, the distance D2 is set such that the radiating element 41 and the metal body 46 are electrically coupled (specifically, such that they are capacitively coupled).

### Distance D3

In an embodiment of the present disclosure, in plan view, the center of the radiating element 41 lies within the opening of the metal body 46 (included within the area of the opening), and the center of the radiating element 41 and the metal part of the metal body 46 are nonoverlapping. Further, in an embodiment of the present disclosure, the size of the metal body 46 is designed such that an overlapping area is created between the radiating element 41 and the metal part of the metal body 46 in plan view. The metal part of the metal body 46 is a part of the metal body 46 other than the opening. Further, hereinafter, unless otherwise specified, the metal body 46 refers to the metal part of the metal body 46.

Specifically, the size of the metal body 46 is adjusted such that the inner edge of the metal body 46 in a surrounding shape is on the side of the center of the radiating element 41 relative to the outer edge of the radiating element 41, in plan view. In such a case, the distance D3 between the outer edge of the radiating element 41 and the inner edge of the metal body 46 is positive (>0).

Incidentally, the parasitic capacitance between the metal body 46 and the radiating element 41 increases with an increase in the distance D3. Thus, in an embodiment of the present disclosure, the shape (distance D3) of the metal body 46 is determined such that the metal body 46 and the slots 70 of the radiating element 41 are nonoverlapping (the metal body 46 does not cover the slots 70), in plan view. With the metal body 46 being formed in such a shape, it is possible to prevent significant change in the impedance of the patch antenna 35. Here, the slot 70 corresponds to an “opening” of the radiating element 41.

Further, in the patch antenna 35 of an embodiment of the present disclosure, the distance D3 is positive, but it is not limited thereto. Specifically, it is enough for the metal body 46 to be arranged at a position corresponding to the wave source of the radiating element 41 such that the axial ratio of the patch antenna 35 can be adjusted. Thus, the shape of the metal body 46 may be adjusted such that the outer edge of the radiating element 41 and the inner edge of the metal body 46 are aligned with each other (such that the distance D3 is zero) in plan view. Further, the shape of the metal body 46 may be adjusted such that the radiating element 41 and the metal body 46 are nonoverlapping in plan view (such that the distance D3 is negative).

Further, for example, when the parasitic capacitance of the patch antenna 35 is small, the metal body 46 may cover the slot 70 in plan view.

### Characteristics of Patch Antenna 30

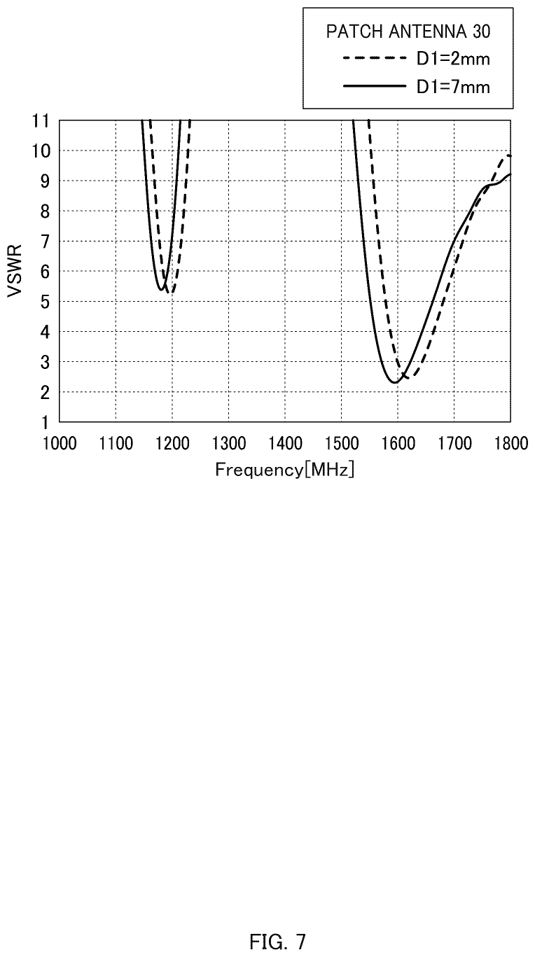

FIG. 7 is a diagram illustrating the relationship between the frequency and the Voltage Standing Wave Ratio (VSWR) of the patch antenna 30 in the vehicular antenna device 10. In FIG. 7, when the distance D1 between the radiating element 41 and the metal body 42 is changed from D1=7 mm (solid line) to D1=2 mm (dotted line), the parasitic capacitance increases. As a result, the impedance of the patch antenna 30 changes, so that the frequency at which the VSWR is minimum rises in each of the L1 band and the L5 band.

Accordingly, in order to operate the patch antenna 30 in a desired frequency band with the distance D1 being set to 2 mm, for example, the size of the radiating element 41 needs to be readjusted.

### Characteristics of Patch Antenna 35

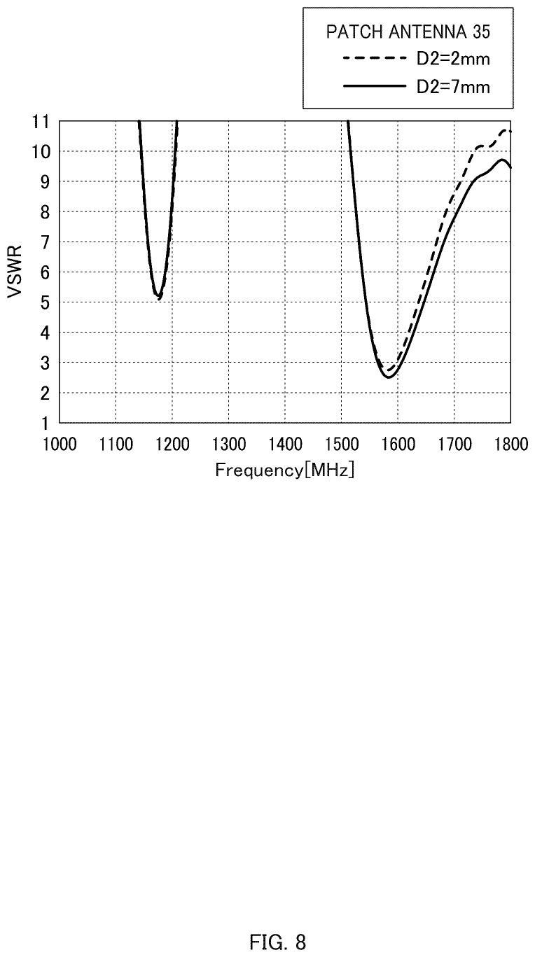

FIG. 8 is a diagram illustrating the relationship between the VSWR and the frequency of the patch antenna 35 of the vehicular antenna device 11. In FIG. 8, even when the distance D2 between the radiating element 41 and the metal body 42 is changed from D2=7 mm (solid line) to D2=2 mm (dotted line), the characteristics of the VSWR are substantially unchanged.

Accordingly, for example, in the patch antenna 35, even if the distance D2 is set to, for example, 2 mm, it is possible to suppress change in the impedance of the patch antenna 35. Thus, in the patch antenna 35, it is possible to adjust the axial ratio while suppressing the influence on the impedance of the patch antenna 35.

### Other Embodiments of Patch Antenna 35

### Other Embodiments of Metal Body

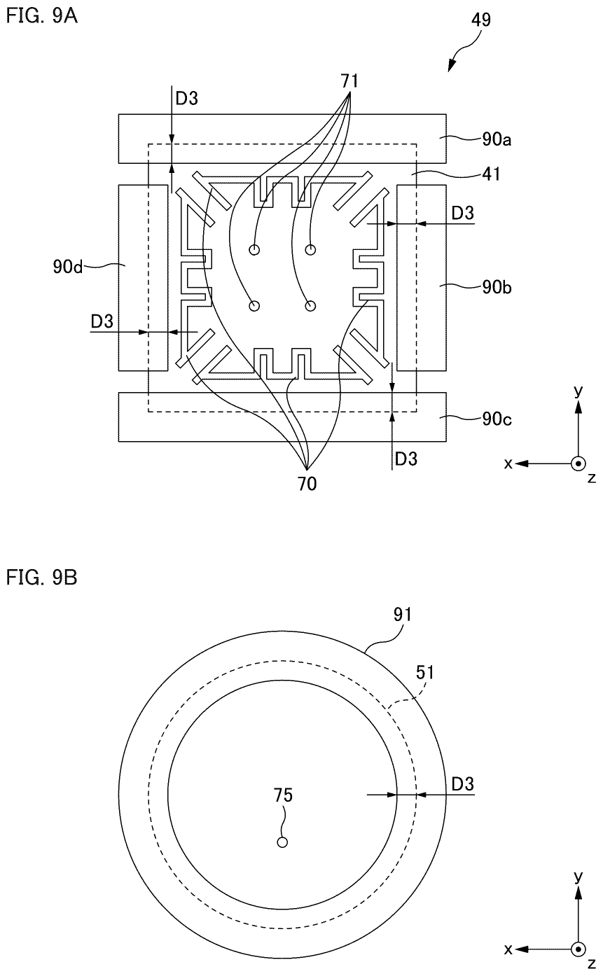

The metal body 46 of an embodiment of the present disclosure has such a surrounding shape that completely surrounds the center of the radiating element 41, however, it is not limited thereto. For example, as illustrated in FIG. 9A, the metal body 49 may have such a surrounding shape that surrounds the center of the radiating element 41 including four metal plates 90a to 90d with a gap between any adjacent two of the metal plates 90a to 90d.

Here, the metal body 49 has a gap between the metal plates 90a and 90d, between the metal plates 90a and 90d, between the metal plates 90a and 90d, and between the metal plates 90a and 90d. However, the metal body 49 may have a structure in which two adjacent metal plates are connected with a conductor and/or the like in at least one place between two adjacent metal plates of the adjacent metal plates 90a to 90d. In such a case, the distance D3 can be determined, for example, by the side of the metal plate 90a closer to the center of the radiating element 41 and the outer edge of the radiating element 41.

As illustrated in FIG. 9A, it is enough for the metal parts of the metal body 49 (that is, the metal plates 90a to 90d) to have a shape that is arranged at a position corresponding to the wave source of the radiating element 41 without covering the center of the radiating element 41. With such an arrangement, it is possible to suppress change in the impedance of the patch antenna.

### Other Embodiments of Radiating Element and Metal Body

Further, in an embodiment of the present disclosure, the radiating element 41 is in a shape of the substantial square, however, it is not limited thereto, and may be in a shape of, for example, a circle, an oval, and a substantial polygon other than a substantial quadrangle including a substantial square and a substantial rectangle. For example, FIG. 9B illustrates a circular radiating element 51 having a feeding point 75.

The radiating element 51 as such may use a metal body 91 having a surrounding shape that surrounds the center of the radiating element 51 with a circle. In this case, the distance D3 can be determined by the inner edge of the metal body 91 and the outer edge of the radiating element 51.

In this way, the metal body may have a surrounding shape of, for example, a circle, an oval, and a substantial polygon other than a substantial quadrangle. Then, the metal body preferably has a shape that surrounds the center of the radiating element and overlaps the wave source (end) of the radiating element in plan view.

As described above, the phrase “the metal body surrounds the center of the radiating element” may mean, for example, that the metal body completely surrounds the center of the radiating element, without any gap, as illustrated in FIG. 6, or that multiple metal members surround the center of the radiating element, with a gap therebetween, as illustrated in FIG. 9A. In such a case, the multiple metal members correspond to the “metal body”. Here, the state in which the multiple metal members surround the center of the radiating element, with a gap therebetween, includes, for example, a state in which any of the metal plates 90a to 90d in FIG. 9A is absent.

Further, when a metal body is used for a radiating element that supports linearly polarized waves, it is enough for the metal body to be present only in the direction in which radio waves are radiated from the wave source of the radiating element. Thus, in such a case, the metal body does not necessarily have to have a surrounding shape. When, in FIG. 9A, the wave sources are present only at the sides of the radiating element 41 in the x-axis direction, only two metal plates 90b and 90d are needed among the metal plates 90a to 90d. Even in such a case, it is possible to obtain effect similar to that of an embodiment of the present disclosure.

### When Radiating Element Includes Two Electrodes

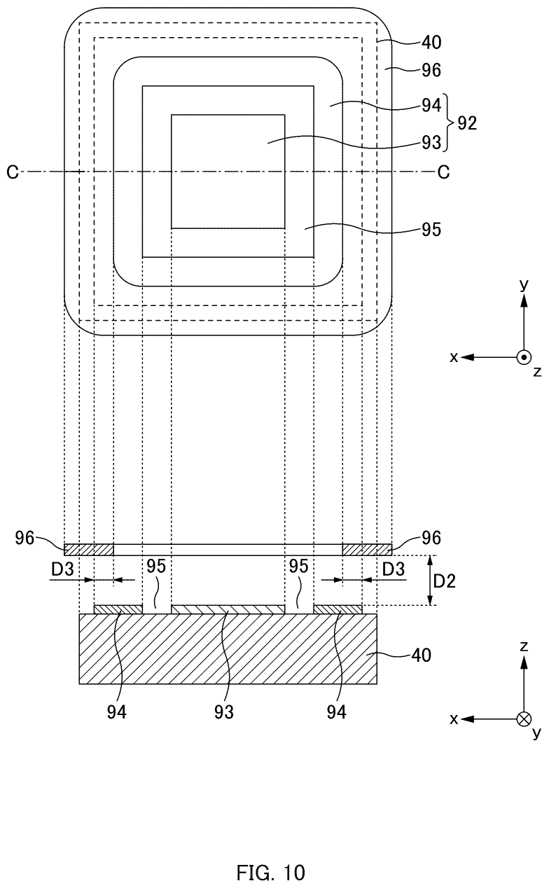

FIG. 10 is a schematic diagram illustrating the relationship between a radiating element 92 including two electrodes and a metal body 96. The radiating element 92 includes a conductive pattern (metal pattern) 93 (first electrode) in a substantially square shape and a conductive pattern (metal pattern) 94 (second electrode) in a surrounding shape that surrounds the conductive pattern (metal pattern) 93. An opening 95, which is a region where there is no conductive pattern (a region in which the front surface of the dielectric 40 is exposed) is formed between the conductive pattern 93 and the conductive pattern 94.

In such a case, the metal body 96 preferably has such a shape in which the metal body 96 and the conductive pattern 93 on the outer side of the radiating element 92 overlap and the metal body 96 and the opening 95 are nonoverlapping, in plan view. With the metal body 96 being formed in such a shape, the parasitic capacitance between the radiating element 92 and the metal body 96 can be reduced, thereby being able to suppress change in the impedance of the patch antenna.

### Others

In an embodiment of the present disclosure, the patch antenna has a structure in which a main body portion including a dielectric and a radiating element has one stage, but the present disclosure is not limited thereto, and a stacked or multilayer patch antenna may be used. In such a case, it is enough that the metal body is arranged, with the above-described condition (for example, D3>0), at the radiating element provided in the top stage of the patch antenna. The stacked and multi-layered patch antennas will be described later in detail.

### Vehicular Antenna Device 12

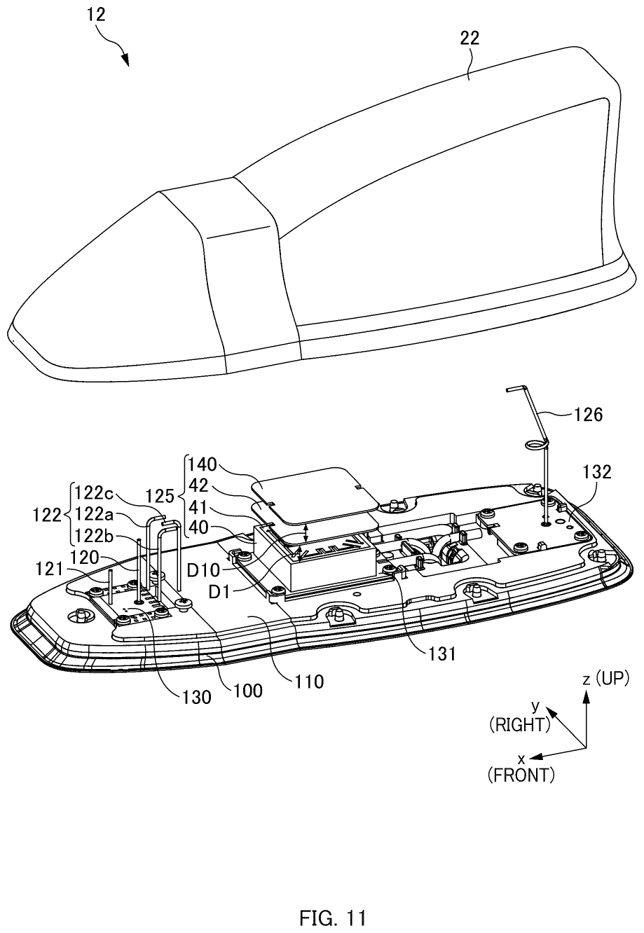

FIG. 11 is a diagram illustrating a configuration of the vehicular antenna device 12. The vehicular antenna device 12 includes the case 22, an antenna base 100, a metal base 110, antennas 120, 126, parasitic elements 121, 122, a patch antenna 125, and substrates 130 to 132.

The antenna base 100 is a plate-shaped member that serves as the bottom surface of a vehicular antenna device 13 while forming a housing space together with the case 22. The antenna base 100 is, for example, an insulating base made of resin, and is attached with the metal base 110 that functions as a ground using multiple screws (not illustrated). Since the antenna base 100 is the same as or similar to the antenna base 20, detailed description is omitted.

The antenna 120 is a vertically polarized monopole antenna used for V2X communication. The antenna 120 is a metal bar-shaped member that operates as a grounded monopole antenna, and is provided to the substrate 130. The substrate 130 is provided to the metal base 110.

The parasitic elements 121 and 122 are elements to improve the directivity while increasing the gain in the front (+x direction) of the antenna 120. The parasitic element 121 is a rod-shaped metal body that functions as a so-called wave director with respect to the antenna 120, and is mounted on the front side relative to the antenna 120. Each of the parasitic elements 122a to 122c is a rod-shaped metal body that functions as a so-called reflector with respect to the antenna 120, and is mounted on the rear side relative to the antenna 120.

The patch antenna 125, as with the patch antenna 30, is an antenna that supports the L1 and L5 bands for GNSS, and is mounted to the substrate 131 provided to the metal base 110. The patch antenna 125 includes the dielectric 40, the radiating element 41, and the metal body 42 and a metal body 140.

In the patch antenna 125, the metal body 140 is added to the components of the patch antenna 30 (the dielectric 40, the radiating element 41, and the metal body 42). The metal body 140 is, as with the metal body 42, a top plate provided to further adjust the axial ratio of the patch antenna 125.

The metal body 140 is held by a holding member (not illustrated) such that the back surface of the metal body 140 is spaced apart from the front surface of the metal body 42 by a distance D10. The metal body 140 is, as with the metal body 42, larger in area than the radiating element 41, and has a substantially square shape.

The antenna 126 is a vertically polarized collinear antenna array used for V2X communication, and is attached to the substrate 132 provided to the metal base 110.

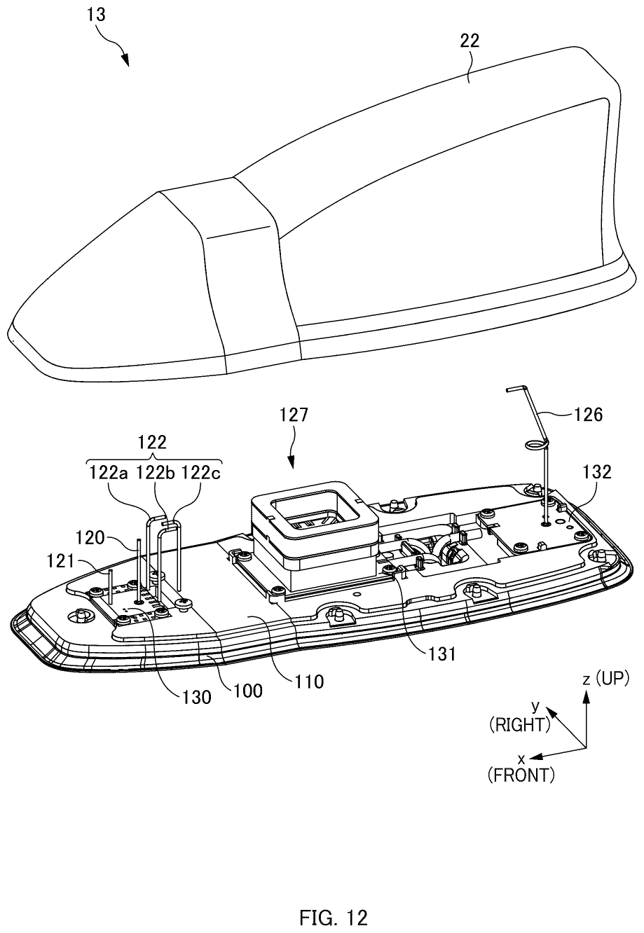

In the vehicular antenna device 12, the two metal bodies 42, 140 are provided above the radiating element 41 to improve the axial ratio of the patch antenna 125. However, depending on the positions of the metal bodies 42 and 140, for example, the parasitic capacitance caused by the metal body 140 may increases. A vehicular antenna device 13 illustrated in FIG. 12 includes a patch antenna that suppresses the influence of the parasitic capacitance and has a small change in the impedance regardless of the positions of metal bodies.

### Vehicular Antenna Device 13 (Second Embodiment)

FIG. 12 is a perspective view of the vehicular antenna device 13 in an embodiment of the present disclosure. The vehicular antenna device 13 includes the case 22, the antenna base 100, the metal base 110, the antennas 120 and 126, the parasitic elements 121 and 122, a patch antenna 127, and the substrates 130 to 132.

When comparing between the vehicular antenna device 13 in FIG. 12 and the vehicular antenna device 12 in FIG. 11, they have the same configuration except for the patch antenna 127. Accordingly, the patch antenna 127 will be described here.

### Patch Antenna 127

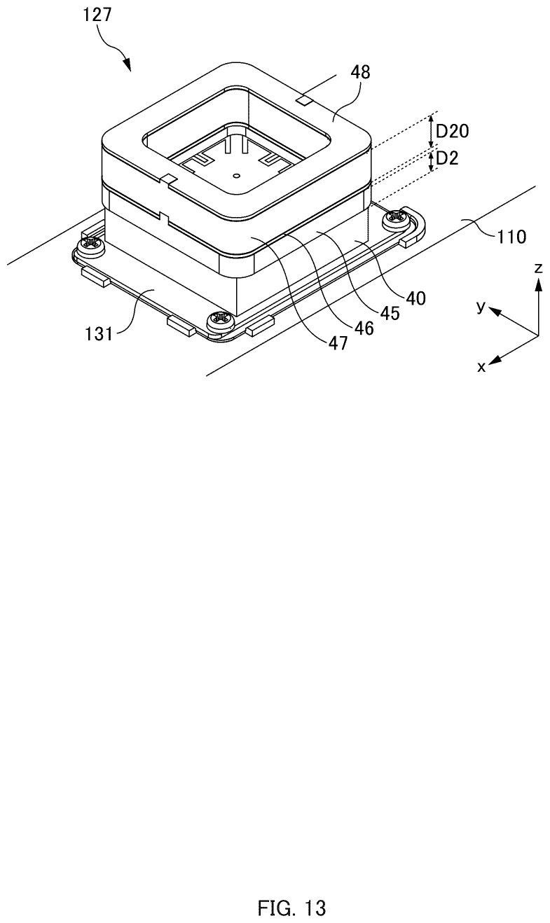

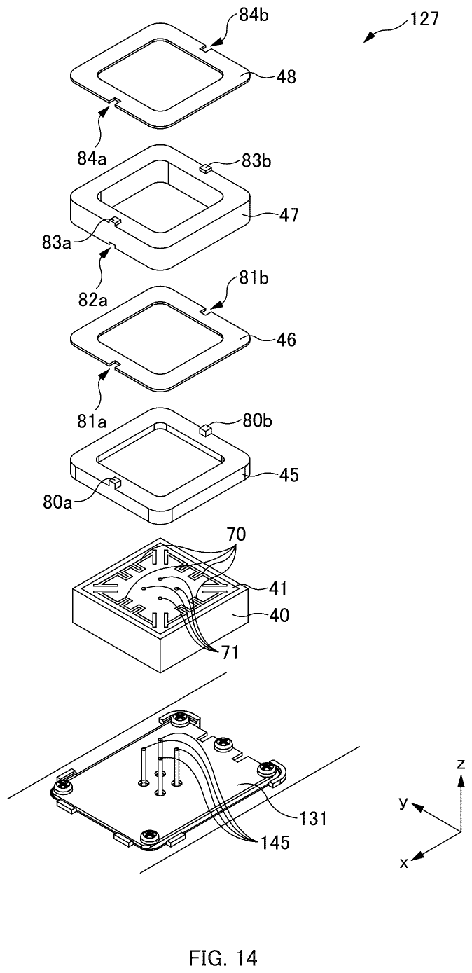

The patch antenna 127 is, as with the patch antenna 35, an antenna that supports radio waves in the L1 band and L5 band for GNSS. FIG. 13 is an enlarged view of the patch antenna 127, and FIG. 14 is an exploded perspective view of the patch antenna 127.

The patch antenna 127 includes the dielectric 40, the radiating element 41, the holding member 45, a holding member 47, the metal body 46, and a metal body 48. When the patch antenna 127 is mounted to the substrate 131, as in the patch antenna 35, the four feed lines 145 are respectively connected to the four feeding points 71 of the radiating element 41.

Here, the patch antenna 127 further includes the holding member 47 and the metal body 48, in addition to the patch antenna 35 having the single metal body 46 in FIG. 4. Thus, the holding member 47 and the metal body 48 will be mainly described here.

The holding member 47 is a frame-shaped member made of resin, and is provided at the front surface of the metal body 46 that is a first one. At the back surface of the holding member 47, a recessed portion 82a and a recessed portion 82b (not illustrated in the figures) are respectively formed near the centers of two sides parallel to the y-axis.

In an embodiment of the present disclosure, the recessed portions 82a and 82b are designed such that the recessed portions 82a, 82b and the recessed portions 84a and 84b are aligned with each other, respectively, in plan view, when the holding member 47 is provided to the front surface of the metal body 46.

As a result, when the holding member 45, the metal body 46, and the holding member 47 are stacked, the protruding portion 80a is fitted in the recessed portions 81a and 82a, and the protruding portion 80b is fitted in the recessed portions 81b and 82b.

Further, protruding portions 83a and 83b are respectively formed near the centers of two sides, parallel to the y-axis, at the front surface of the holding member 47. As with the metal body 46, the metal body 48 is a surrounding-shaped member (top plate), and recessed portions 84a and 84b are respectively formed near the centers of a side on the +x side and a side on the −x side, which are parallel to the y axis.

In an embodiment of the present disclosure, the metal body 48 is arranged at the front surface of the holding member 47 in a state where the protruding portions 83a and 83b of the holding member 47 are fitted in the recessed portions 84a and 84b of the metal body 48, respectively. Accordingly, the center of the holding member 47 and the center of the metal body 48 are substantially aligned with each other.

Incidentally, the holding member 45 in the first stage in an embodiment of the present disclosure is provided on the dielectric 40 such that the center of the holding member 45 is aligned with the center of the radiating element 41. Accordingly, the holding member 45 holds the metal body 46 such that the center of the radiating element 41 is aligned with the center of the metal body 46.

Further, the holding member 47 is also provided on the metal body 46 such that the center of the holding member 47 is aligned with the center of the metal body 46. Accordingly, the holding member 47 results in holding the metal body 48 such that the center of the metal body 46 is aligned with the center of the metal body 48.

In the patch antenna 127, all the centers of the radiating element 41 and the metal bodies 46 and 48 in a shape of the substantial square are substantially aligned with one another as such, and thus it is possible to further improve the axial ratio. Further, in such a configuration, it is possible to downsize the patch antenna 127 more than, for example, the case where the centers of the radiating element 41 and the metal bodies 46 and 48 are out of alignment.

Here, the metal body 46 corresponds to a “first metal body” that is provided closest to the radiating element 41 in a direction perpendicular to the upper surface (corresponding to the front surface) of the radiating element 41. Further, the metal body 48 corresponds to a “second metal body” provided closest to the metal body 46 in the direction perpendicular to the upper surface of the radiating element 41. Thus, the metal body 46 is provided between the radiating element 41 and the metal body 48. Further, the holding member 45 corresponds to a “first holding member”, and the holding member 47 corresponds to a “second holding member”.

### Characteristics of Patch Antenna 125

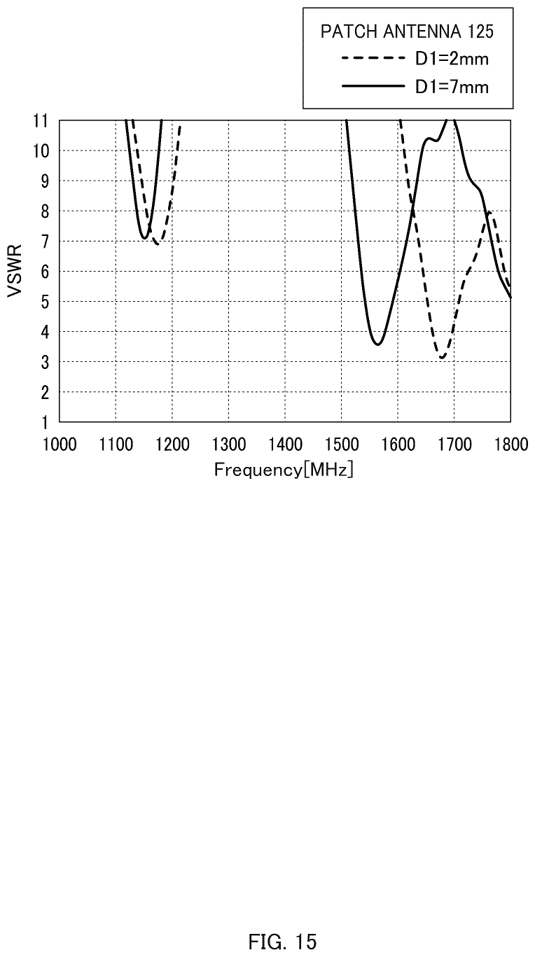

FIG. 15 is a diagram illustrating the relationship between the VSWR and the frequency of the patch antenna 125 in the vehicular antenna device 12. FIG. 15 illustrates the characteristics when the distance DI between the radiating element 41 and the metal body 42 is changed from D1=7 mm (solid line) to D1=2 mm (dotted line). Here, the distance D10 between the metal body 42 and the metal body 140 is D10=6.7 mm.

As is apparent from FIG. 15, when the distance D1 is reduced, not only the parasitic capacitance caused by the metal body 42 but also the parasitic capacitance caused by the metal body 140 increases. As a result, the impedance of the patch antenna 30 changes significantly, and the frequency at which the VSWR is minimum increases in each of the L1 band and the L5 band.

Accordingly, in order to operate the patch antenna 125 in a desired frequency band, for example, with the distance D1 being 2 mm, for example, the size of the radiating element 41 needs to be adjusted.

### Characteristics of Patch Antenna 127

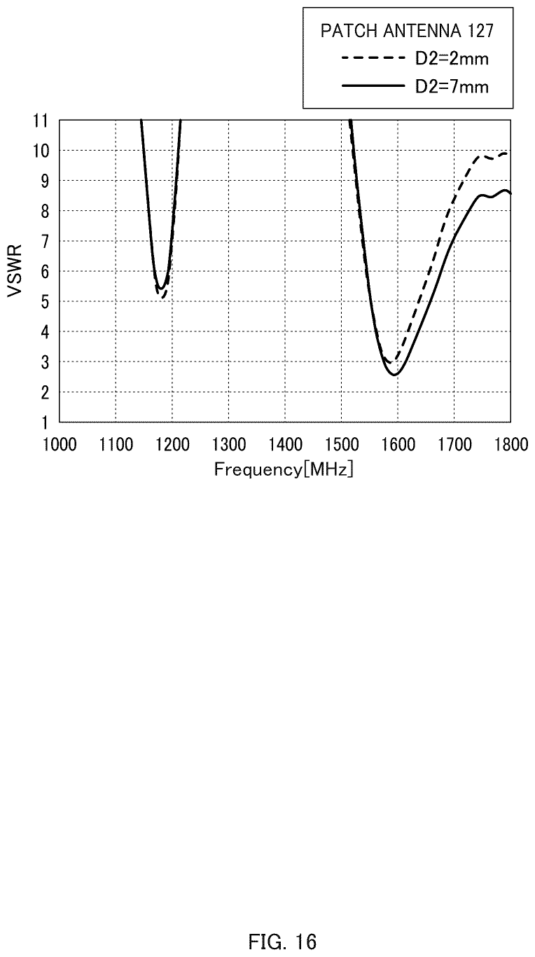

FIG. 16 is a diagram illustrating the relationship between the VSWR and the frequency of the patch antenna 127 of the vehicular antenna device 13. Here, the distance D20 between the front surface of the metal body 46 of the patch antenna 127 and the back surface of the metal body 48 is, for example, D20=6.7 mm.

In FIG. 16, even when the distance D2 between the radiating element 41 and the metal body 42 is changed from D2=7 mm (solid line) to D2=2 mm (dotted line), change in the VSWR characteristics is smaller than in FIG. 15.

Accordingly, for example, in the patch antenna 127, even when the distance D2 is set to, for example, 2 mm, it is possible to suppress change in the impedance of the patch antenna 127. Thus, in the patch antenna 127, it is possible to adjust the axial ratio while suppressing the influence on the impedance of the patch antenna 127.

### Vehicular Antenna Device 14 (Third Embodiment)

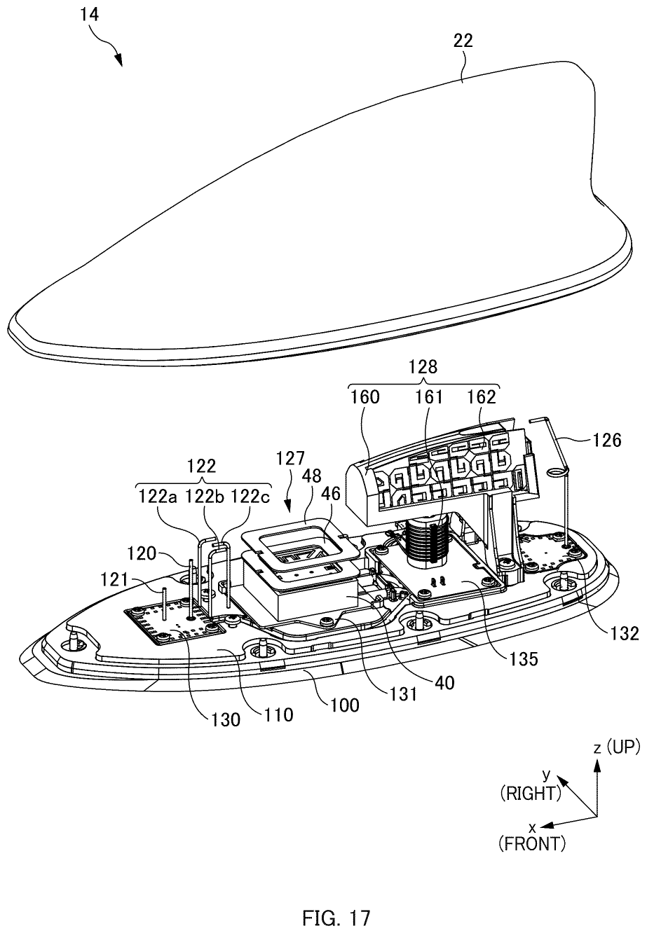

FIG. 17 is a diagram illustrating a configuration of a vehicular antenna device 14 according to an embodiment of the present disclosure. The vehicular antenna device 14 includes the case 22, the antenna base 100, the metal base 110, the antennas 120 and 126, an antenna 128, the parasitic elements 121 and 122, the patch antenna 127, and the substrates 130 to 132, and a substrate 135. In FIG. 17, the holding members 45 and 47 in the patch antenna 127 are omitted to facilitate understanding of the configuration thereof.

In the vehicular antenna device 14, the antenna 128 is added to the vehicular antenna device 13 of FIG. 12. Accordingly, the antenna 128 will be mainly described here.

The antenna 128 is, an antenna to receive radio waves for AM/FM radio, for example, and includes a holder 160, a helical element (coil) 161, and a capacitive loading element 162. The antenna 128 may be, for example, an antenna to receive signals in other band in the Digital Audio Broadcast (DAB) waveband, such as the L-Band (1452 MHz to 1492 MHz).

The holder 160 is a resin member that holds the helical element 161 and the capacitive loading element 162, and is attached to the metal base 110. The helical element 161 is attached to the cylindrical portion of the holder 160. The helical element 161 has one end to be electrically connected to the substrate 135 provided to the metal base 110, and the other end to be electrically connected to the capacitive loading element 162.

The capacitive loading element 162 is an element configured to resonate in a desired frequency band, with the helical element 161. The capacitive loading element 162 includes multiple metal bodies attached to each of the left and right side surfaces of the upper part of the holder 160.

In FIG. 17, although only multiple metal bodies on the left side of the upper part of the holder 160 are illustrated, for convenience, multiple metal bodies as those on the left side are attached to the holder 160 on the right side as well. Further, in an embodiment of the present disclosure, a metal plate (not illustrated) to connect the multiple metal bodies on the left side and the right side of the capacitive loading element 162 is included.

When the patch antenna 127 is arranged in such a vehicular antenna device 14, the characteristics (for example, the axial ratio) of the patch antenna 127 may be affected by the antenna 128, for example. However, in the patch antenna 127, the metal bodies 46 and 48 are provided above the wave source, and thus the axial ratio of the patch antenna 127 can be adjusted.

Further, the metal bodies 46 and 48 have a surrounding shape that surrounds the center of the radiating element 41, and thus change in the impedance of the patch antenna 127 can be suppressed.

### Vehicular Antenna Device 15 (Fourth Embodiment)

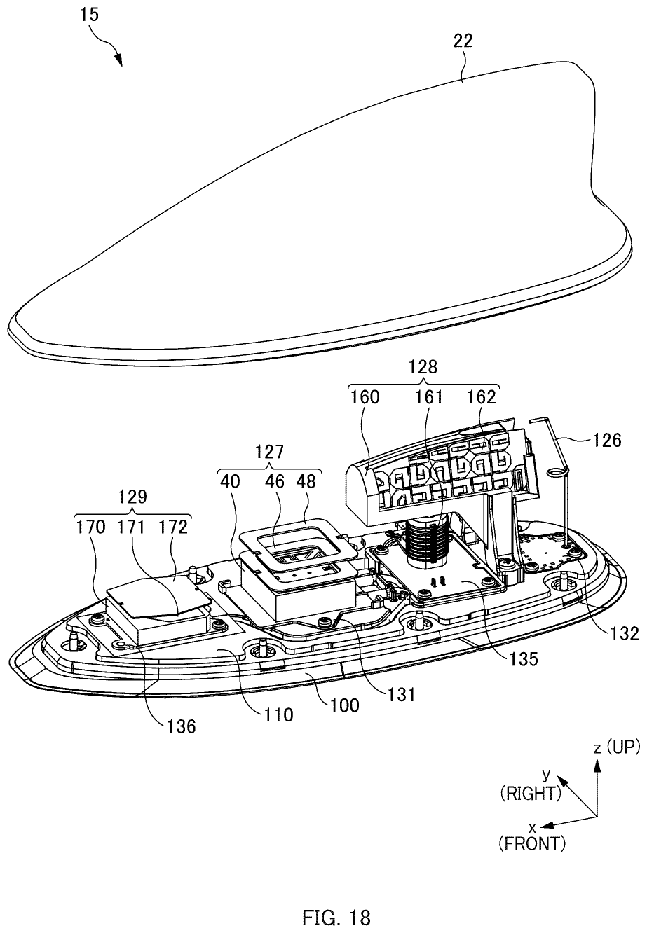

FIG. 18 is a diagram illustrating a configuration of a vehicular antenna device 15 according to an embodiment of the present disclosure. The vehicular antenna device 15 includes the case 22, the antenna base 100, the metal base 110, the antennas 126 and 128, the patch antenna 127, a patch antenna 129, and the substrates 131, 132, and 135, and a substrate 136. In FIG. 18, the holding members 45 and 47 of the patch antenna 127 are omitted to facilitate understanding of the configuration.

In the vehicular antenna device 15, the patch antenna 129 is added in place of the antenna 120 and the like of the vehicular antenna device 13 of FIG. 17. Accordingly, the patch antenna 129 will be mainly described here.

The patch antenna 129 is an antenna to receive radio waves in the 2.3 GHz band for a satellite digital audio radio service (SDARS), for example. The patch antenna 129 includes a dielectric 170, a radiating element 171, and a metal body 172, and is attached to the substrate 136 at the front surface of the metal base 110.

The dielectric 170, the radiating element 171, and the metal body 172 in an embodiment of the present disclosure are, for example, the same or similar as the dielectric 40, the radiating element 41, and the metal body 42 of the patch antenna 30 described above, respectively, and thus detailed descriptions thereof are omitted here.

In the case of the vehicular antenna device 15 including multiple antennas as such, the patch antenna 127 may be affected by other antennas. In an embodiment of the present disclosure, in the patch antenna 127, the metal bodies 46 and 48 in a surrounding shape that surrounds the center of the radiating element 41 are provided above the radiating element 41. Thus, it is possible to adjust the axial ratio of the patch antenna 127 while suppressing change in the impedance of the patch antenna 127.

### Vehicular Antenna Device 16 (Fifth Embodiment)

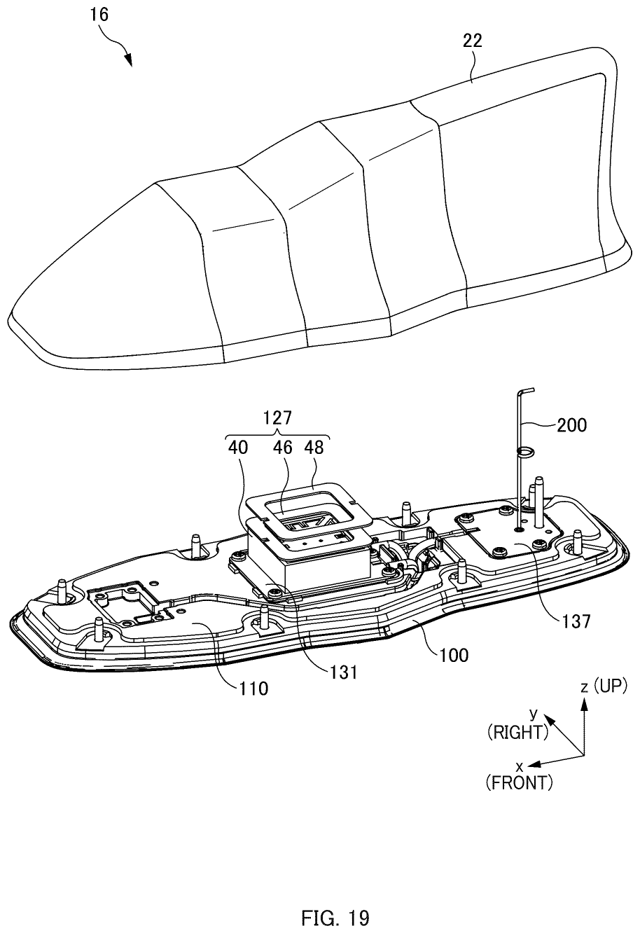

FIG. 19 is a diagram illustrating a configuration of a vehicular antenna device 16 according to an embodiment of the present disclosure. The vehicular antenna device 16 includes the case 22, the antenna base 100, the metal base 110, the patch antenna 127, an antenna 200, the substrate 131, and a substrate 137. In FIG. 19, the holding members 45 and 47 of the patch antenna 127 are omitted to facilitate understanding of the configuration.

The antenna 200 is a vertically polarized antenna used for V2X communication, and is mounted to the substrate 137 that is provided to the metal base 110.

In the vehicular antenna device 16 as such, the patch antenna 127 can adjust the axial ratio while suppressing change in the impedance, as in other embodiments.

### Others

### Direction of Radiation of Radio Waves

In the patch antenna 35 of an embodiment of the present disclosure, it is assumed that the direction in which the intensity of radiation of the radio waves increases (the direction corresponding to the wave source) is the +z direction, but it is not limited thereto. For example, the configuration may include a radiating element in which the direction in which the intensity of radiation of the radio waves of the patch antenna increases is the +x direction. In such a case, with the metal body being arranged at a position spaced apart, in the +x direction, from the front surface of the radiating element, such effect as in an embodiment of the present disclosure can be obtained.

### Holding Member 45, 47

Further, it is assumed that the holding member 45, 47 is frame-shaped member, however, any shape (for example, a support post to support four corners of a metal body) may be applicable as long as it can hold the metal body 46, 48, so as to be located at a desired position. Further, the metal body 46, 48 may be held using a solid base, for example, made of resin, for example, as a holding member.

Furthermore, the metal body 46, 48 may be located at a desired position by attaching the metal body 46, 48 to part of the interior of the case 22. In such a case, the case 22 corresponds to the “holding member”.

### Stacked Patch Antenna

In an embodiment of the present disclosure, the patch antenna 35 includes the single dielectric 40 and the single radiating element 41, however, it is not limited thereto. For example, assuming that the dielectric 40 is a first dielectric and the radiating element 41 provided to the front surface of the first dielectric is a first radiating element, the patch antenna 35 may include a second dielectric provided above the first radiating element and a second radiating element provided at the front surface of the second dielectric.

Alternatively, the patch antenna 35 may include the dielectric 40 and another dielectric that is provided at the front surface of the dielectric 40 and that includes radiating elements at the front surface and the back surface thereof. That is, the numbers of the dielectrics and the radiating elements are not limited to one and may be two or more, and the patch antenna 35 may have a stacked or multi-layered configuration.

Further, in the stacked configuration including the first and second dielectrics and the first and second radiating elements, the multiple metal bodies 46 and 48 described in an embodiment of the present disclosure may be provided above the uppermost second radiating element. In such a case, a configuration including the first and second dielectrics, the first and second radiating elements, and the multiple metal bodies 46 and 48 corresponds to a stacked patch antenna.

In the stacked patch antenna, the first radiating element and the second radiating element may be operated in frequency bands different from each other. As such, it is possible to obtain such effect as in an embodiment of the present disclosure, even in a case of the stacked patch antenna including multiple numbers of the dielectrics and the radiating elements.

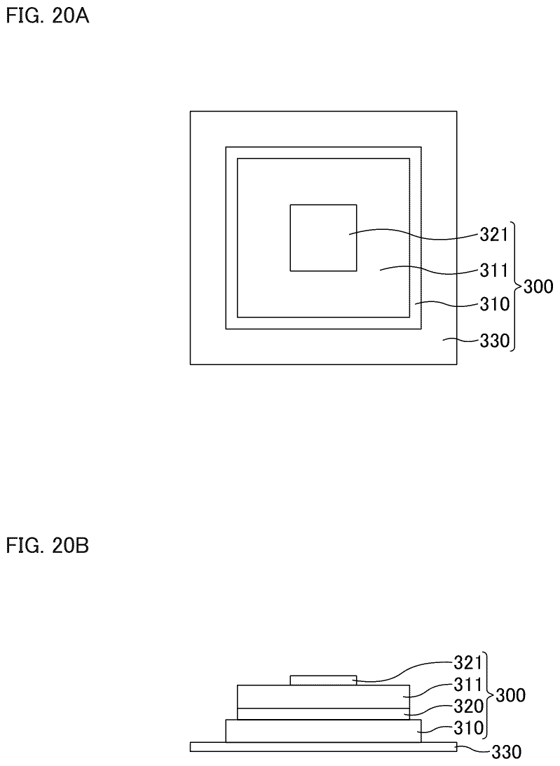

FIGS. 20A and 20B are diagrams illustrating an example of a main body portion 300 of the stacked patch antenna. The stacked patch antenna is, for example, an antenna that supports radio waves in two different frequency bands for the GNSS (e.g., radio waves in the L1 and L2 bands).

The main body portion 300 includes dielectrics 310 and 311 and radiating elements 320 and 321, as illustrated in plan view of FIG. 20A and a side view of FIG. 20B.

The dielectric 310 is, for example, a member that is the same as or similar to the dielectric 40 of the patch antenna 30 in FIG. 1, and is arranged at a substrate 330. The substrate 330 is a circuit board where a pattern (not illustrated) is formed at the back surface thereof.

Further, the conductive radiating element 320 in a shape of the substantial square is formed at the front surface of the dielectric 310. In the main body portion 300, the dielectric 310 (first dielectric), and the radiating element 320 (first radiating element) are components to support a first frequency (for example, a frequency in the L2 band).

The dielectric 311 is arranged at the front surface of the radiating element 320, and the radiating element 321 is arranged at the front surface of the dielectric 311. Here, in the main body portion 300, the dielectric 311 (second dielectric) and the radiating element 321 (second radiating element) are components to support a second frequency different from the first frequency (for example, a frequency in the L1 band).

Further, two metal bodies may be provided above the radiating element 321, as in the patch antennas 125 and 127, with respect to the main body portion 300 as such. Provision of such two metal bodies makes it possible to improve the axial ratio of the stacked patch antenna including the main body portion 300, as in the patch antennas 125 and 127.

### Relationship Between Patch Antenna and Ground Member

When the patch antenna is arranged at the substantial center of a ground member that functions as a ground, the axial ratio of the patch antenna is improved. Here, the “ground member” may be any member as long as it functions as the ground, and may be, for example, a metal base, a metal plate (so-called metal flat plate), and a member that is a combination of a metal base and a metal plate.

Further, the “substantial center” of the ground member includes, for example, the geometric center of the ground member in plan view and is a region smaller than the area of the arranged patch antenna (for example, the area of the patch antenna in plan view). In order to further improve the axial ratio, the patch antenna is preferably arranged at the ground member such that the geometric center of the patch antenna and the geometric center of the ground member are aligned with each other in plan view.

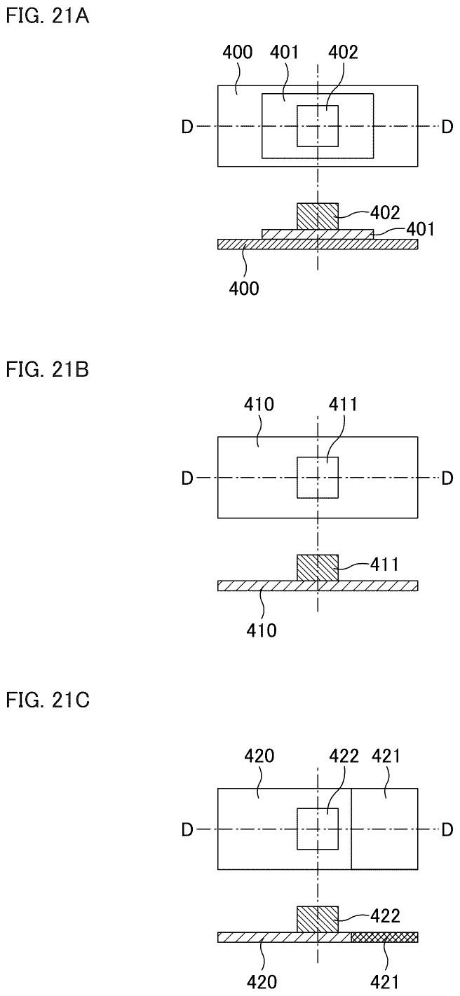

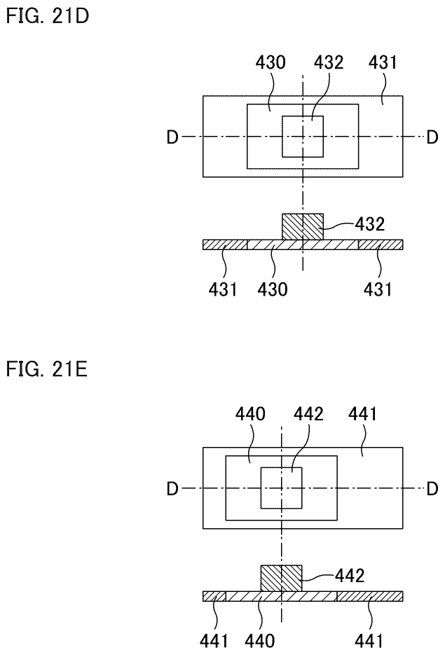

FIGS. 21A to 21E are schematic diagrams illustrating relationships between the patch antenna and the ground member. In each of FIGS. 21A to 21E, the upper part thereof is a plan view, and the lower part thereof is a cross-sectional view taken along a D-D line.

In FIG. 21A, a substrate 401 is provided at the front surface of a metal base 400 serving as the ground member. Further, a patch antenna 402 is provided at the front surface of the substrate 401. Here, in plan view, the patch antenna 402 is provided such that the geometric center of the quadrangular patch antenna 402 and the geometric center of the quadrangular metal base 400 are aligned with each other.

In FIG. 21B, a patch antenna 411 is provided at the front surface of a metal plate 410 serving as the ground member. In FIG. 21B as well, in plan view, the patch antenna 411 is arranged such that the geometric center of the quadrangular patch antenna 411 and the geometric center of the quadrangular metal plate 410 are aligned with each other.

In FIG. 21C, a metal base 420 and a metal plate 421 are connected to each other to function as a single ground. Further, a patch antenna 422 is provided at the front surface of the metal base 420. Here, in plan view, the patch antenna 422 is also arranged such that the geometric center of the quadrangular patch antenna 422 is aligned with the geometric center of the ground member (quadrangle) formed of the metal base 420 and the metal plate 421.

FIG. 21D illustrates a resin base 431 including a metal base 430 in the central portion thereof. Further, a patch antenna 432 is provided at the front surface of the metal base 430. Here, in plan view, the patch antenna 432 is also arranged on the metal base 430 such that the geometric center of the quadrangular patch antenna 432 and the geometric center of the quadrangular metal base 430 are aligned with each other.

FIG. 21E illustrates a resin base 441 including a metal base 440 on the left side of the paper surface in the central portion. As in the case of FIG. 21D, a patch antenna 442 is arranged on the metal base 440 such that the geometric center of the quadrangular patch antenna 442 and the geometric center of the quadrangular metal base 440 are aligned with each other.

It is possible to suppress distortion in the directivity of the patch antenna and improve the axial ratio by arranging the patch antenna at the positions as in FIGS. 21A to 21E. In FIGS. 21A to 21E, each of the patch antenna and the ground member (e.g., the metal base) is illustrated as a quadrangle for the sake of convenience. However, it is not limited thereto and any shapes may be applicable. Here, it is enough for the patch antenna to be arranged such that the geometric center of the patch antenna in plan view is “substantially the center” of the ground member or preferably is aligned with the geometric center thereof.

Further, the patch antennas in FIGS. 21A to 21E are not limited to a patch antenna including a typical dielectric and radiating element. For example, the patch antenna 35 in FIG. 3 and the patch antenna including the stacked main body portion 300 in FIGS. 20A and 20B may be applicable thereto.

### Arrangement of Feed Line

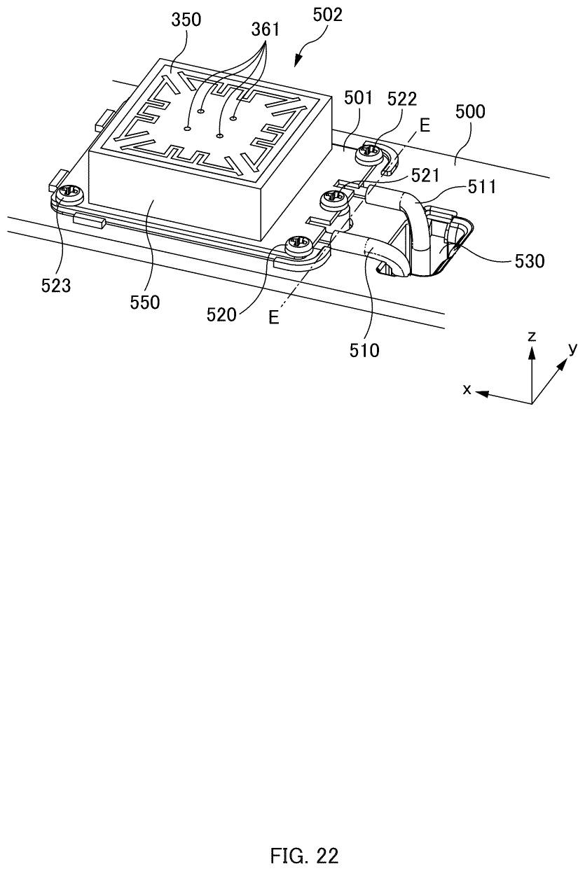

FIG. 22 is a perspective view of an example of a patch antenna. The patch antenna in FIG. 22 is, for example, included in a vehicular antenna device that is the same as or similar to that in FIG. 12, however, here, only a configuration around the patch antenna is illustrated, for convenience. Specifically, FIG. 22 illustrates a metal base 500, a substrate 501, a patch antenna 502, feed lines 510 and 511, and screws 520 to 523.

As in the metal base 110 of the antenna device 13 in FIG. 12, the metal base 500 is a plate-shaped member that functions as a ground, and the substrate 501 is attached to the metal base 500 with five screws (the screws 520 to 523 and a screw 524 (described later)). Further, in the metal base 500, an opening 530 extending through the metal base 500 is provided such that the feed lines 510 and 511 (described later) can be connected with a device outside the vehicular antenna device.

As with the substrate 131 in FIG. 12, the substrate 501 is a circuit board having a back surface at which a pattern (not illustrated) is formed, and the patch antenna 502 is arranged at the substrate 501. The patch antenna 502 is, for example, an antenna that supports the L1 band and the L2 band for the GNSS and includes a dielectric 550 and the radiating element 350. Since the radiating element 350 is the same as or similar to the radiating element 41, detailed description thereof is omitted here.

The feed lines 510 and 511 are coaxial cables connecting the patch antenna 502 and the device outside the vehicular antenna device. An inner conductor (not illustrated) of each of the feed lines 510 and 511 is connected to the feeding points 361 of the radiating element 350 through a conductor (not illustrated) or the like extending through a via hole (not illustrated) in the dielectric 550 or a through-hole provided in the dielectric 550, and an outer conductor (not illustrated) is, for example, connected to a ground portion of the back surface of the substrate 501.

It is assumed here that the two feed lines 510 and 511 are connected to the four feeding points 361, however, it is not limited thereto. For example, when the radiating element has two feeding points, the feed lines 510 and 511 may be connected to the two feeding points. Further, in an embodiment of the present disclosure, the ground portion of the substrate 501 is electrically connected to the metal base 500, which will be described later in detail.

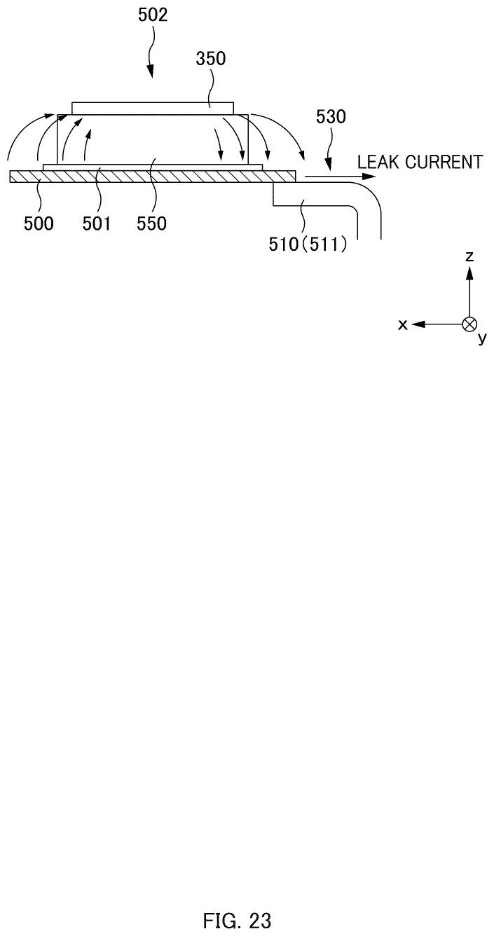

When the patch antenna 502 is operating, an electric field between the radiating element 350 of the patch antenna 502 and the metal base 500 changes. FIG. 23 is a schematic view illustrating electric lines of force between the patch antenna 502 and the metal base 500. As illustrated in FIG. 23, the feed lines 510 and 511 connected to the patch antenna 502 are affected by the electric field. As a result, a leak current may be generated in each of the feed lines 510 and 511 due to the influence of the electric field.

Out of the feed lines 510 and 511, if the feed line 510 is affected more by the electric field than the feed line 511 is, the leak current generated in the feed line 510 increases. As a result, the directivity of the patch antenna 502 may be degraded.

Thus, in an embodiment of the present disclosure, the feed line 510 and the feed line 511 are arranged such that the influences of the electric field on the feed lines 510 and 511 are equalized.

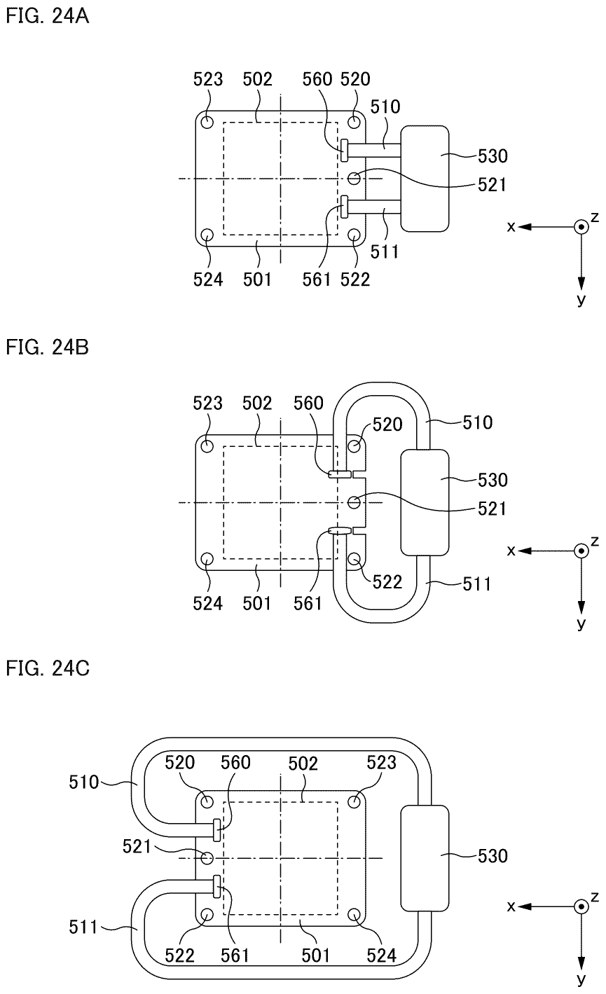

FIGS. 24A to 24C are schematic views to describe the arrangements of the feed lines in the back surface of the substrate 501. FIG. 24A is a schematic view of the metal base 500 in FIG. 22 when viewed from a-z direction, and thus the arrangement of the feed lines will be described first with reference to FIG. 24A.

The schematic views of FIGS. 24A to 24C illustrate such that the geometric center of the quadrangle patch antenna 502 and the geometric center of the quadrangle substrate 501 are illustrated so as to be aligned with each other, in plan view, for the sake of convenience, however, it is not limited thereto.

Connecting portions 560 and 561 are conductive members to which the inner conductors of the feed lines 510 and 511 attached to the back surface of the substrate 501 are connected, respectively. Here, at the back surface of the substrate 501, the connecting portion 560 and the connecting portion 561 are arranged at positions that are symmetric with respect to the axis extending in the x direction passing through the geometric center of the patch antenna 502.

Further, in an embodiment in FIG. 22 (FIG. 24A), the feed line 510 and the feed line 511 are arranged so as to be symmetric, with respect to the axis in the x direction passing through the geometric center of the patch antenna 502, from the connecting portions 560 and 561 to the opening an 530. With such arrangement, it is possible to substantially equalize the influences on the connecting portions 560 and 561 from the electric field of the patch antenna 502.

The arrangement of the feed line 510 and the feed line 511 herein are “symmetric” with respect to the axis in the x direction passing through the geometric center of the patch antenna 502, however, any arrangement may be applicable as long as the respective influences of the electric field on the feed lines 510 and 511 are substantially equal. Accordingly, the feed line 510 and the feed line 511 may be substantially symmetric with respect to the axis in the x direction passing through the geometric center of the patch antenna 502 such that the influences of the electric field received thereby are substantially equalized.

Further, the electric field from the patch antenna 502 decreases with distance from the patch antenna 502. Thus, any arrangement may be applicable as long as drawn-out portions of the feed line 510 and the feed line 511 that are relatively greatly influenced by the electric field are arranged substantially symmetrically, for example. Here, the terms “drawn-out portion of a feed line” indicates, for example, a portion of the feed line from the connecting portion to a part at which the feed line is drawn out linearly (the part at which the feed line is bent).

FIGS. 24B and 24C are diagrams illustrating other arrangement examples of the feed lines 510 and 511. Even with such arrangements, the influences of the electric field on the feed lines 510 and 511 are substantially equalized, thereby being able to improve the directivity of the patch antenna 502.

### Enhancement of Ground Function of Substrate 501

In order to suppress the influences of the electric field on the feed lines 510 and 511, it is effective to enhance a ground function of the substrate 501 that is provided so as to cover a part of the feed lines 510 and 511. Thus, in an embodiment in FIG. 22, the impedance between the metal base 500 and the ground portion of the substrate 501 is reduced, with the screw 521 being provided in addition to the screws 520 and 522 to 524 at four corners of the substrate 501.

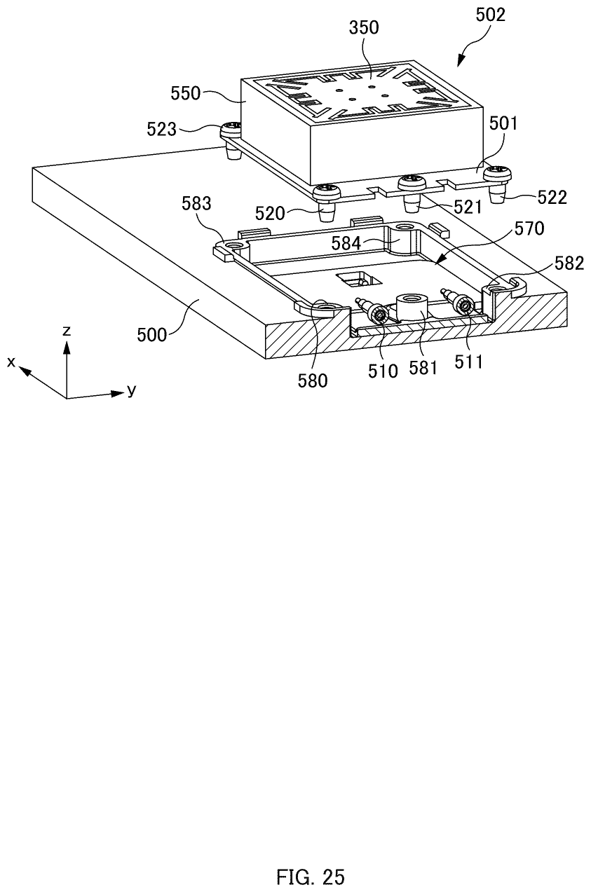

FIG. 25 is a cross-sectional perspective view taken along an E-E line in an embodiment of FIG. 22. Here, various elements (for example, a capacitor and a coil) (not illustrated) are mounted to the back surface of the substrate 501. Thus, a recessed space 570 in a substantially rectangular parallelepiped shape is formed in the metal base 500 such that the substrate 501 with those elements mounted thereto can be attached to the metal base 500.

Support portions 580 and 582 to 584 to support the substrate 501 are formed at four corners of the space 570. Further, in an embodiment of the present disclosure, a support portion 581 to support the substrate 501 and also enhance the ground function of the substrate 501 is formed between the support portion 580 and the support portion 582.

Further, screw holes corresponding to the conductive screws 520 to 524 are formed in the support portions 580 to 584, respectively. Thus, when the screws 520 to 524 are attached in a state where the support portions 580 to 584 are supporting the substrate 501, the substrate 501 is fixed to the metal base 500.

Here, in the substrate 501, conductive ground portions (not illustrated) are formed where the screws 520 to 524 are attached and where supported by the support portions 580 to 584. Accordingly, when the conductive screws 520 to 524 are attached in a state where the substrate 501 is supported by the metal base 500, the metal base 500 and the substrate 501 are electrically connected to each other.

Further, in an embodiment in FIGS. 22 and 25, the feed line 510 (first feed line) is arranged in a region (first region) formed between the support portion 580 and the support portion 581, and the feed line 511 (second feed line) is arranged in a region (second region) formed between the support portion 581 and the support portion 582.

Accordingly, both the feed lines 510 and 511 are partially covered with the substrate 501 having a ground function enhanced by virtue of the screw 521 and the support portion 581. As a result, in an embodiment of the present disclosure, it is possible to suppress the influences of the electric field on the feed lines 510 and 511. Further, since the ground function of the substrate 501 is enhanced, it is also possible to suppress the influence of noise (for example, radiation noise) from the feed lines 510 and 511.

In an embodiment of the present disclosure, the substrate 501 is fixed to the metal base 500 by attaching the screws 520 to 524 into the screw holes of the support portions 580 to 584, however, it is not limited thereto. For example, the substrate 501 may be directly fixed to the support portions 580 to 584 by soldering and/or the like. Even in such a case, it is possible to obtain a similar effect as in the case of using the screws.

### Shield

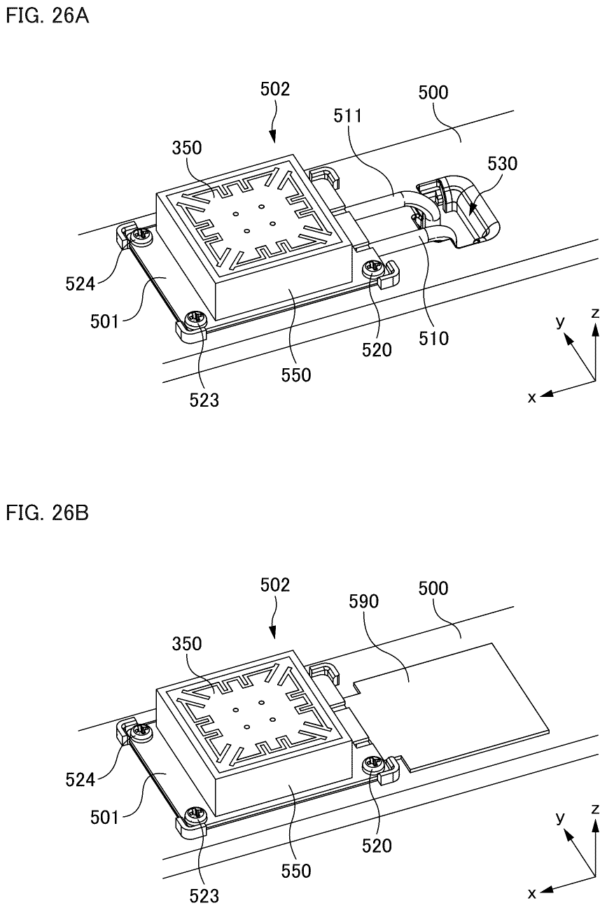

With reference to FIG. 25 and the like, it has been described that the ground function of the substrate 501 is enhanced in order to suppress the influences on the feed lines 510 and 511 or the influences from the feed lines 510 and 511, however, for example, a shield member may be used as illustrated in FIG. 26B.

FIGS. 26A and 26B are diagrams for describing a relationship between the patch antenna 502 and the shield member. FIG. 26A illustrates a state without a shield member, and FIG. 26B illustrates a state with the shield member. A configuration other than the shield member in FIG. 26B is the same as in FIG. 22 and the like, for example, and thus the shield member is mainly described.

A shield member 590 is a metal plate provided to cover the feed lines 510 and 511 and the opening 530 in the front surface of the metal base 500. Further, the shield member 590 is, for example, electrically connected to the metal base 500 with a conductive screw (not illustrated).

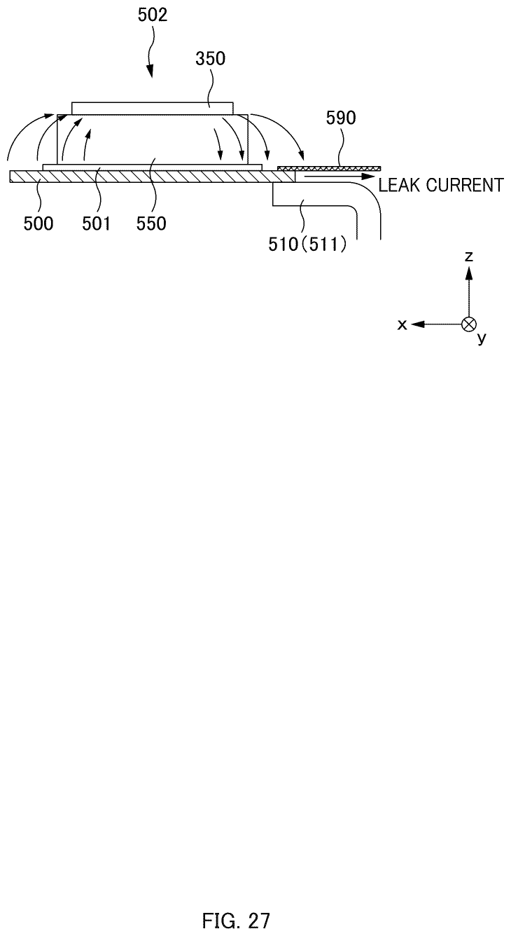

As a result, for example, as illustrated in FIG. 27, it is possible to prevent the electric field from the patch antenna 502 from influencing the feed lines 510 and 511. Further, the shield member 590 can suppress the influence from noise generated by the feed lines 510 and 511 on a device (e.g., the patch antenna 502) provided to the front surface of the metal base 500.

The shield member 590 herein covers the entire feed lines 510 and 511 extending from the substrate 501, however, the shield member 590 may cover a part thereof. Further, instead of the shield member 590, a ferrite core may be attached to the feed lines 510 and 511. Even with such a configuration, it is possible to obtain effect similar to that of an embodiment of FIG. 26B.

### Vehicular Antenna Device 17 (Sixth Embodiment)

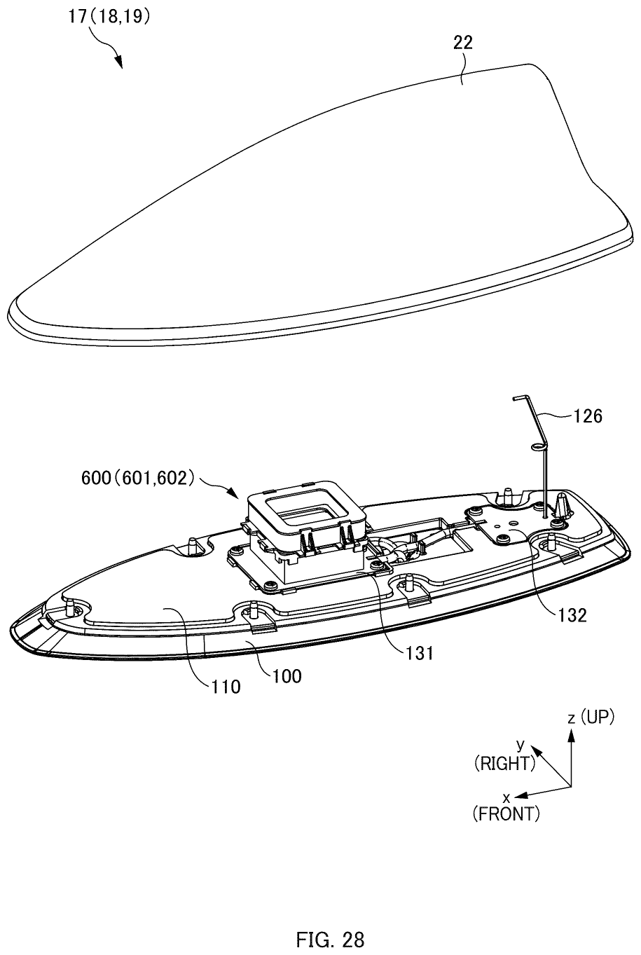

FIG. 28 is a diagram illustrating a configuration of a vehicular antenna device 17 according to an embodiment of the present disclosure. The vehicular antenna device 17 includes the case 22, the antenna base 100, the metal base 110, an antenna 126, substrates 131 and 132, and a patch antenna 600. In the vehicular antenna device 17, since the components other than the patch antenna 600 have already been described, the patch antenna 600 will be described here.

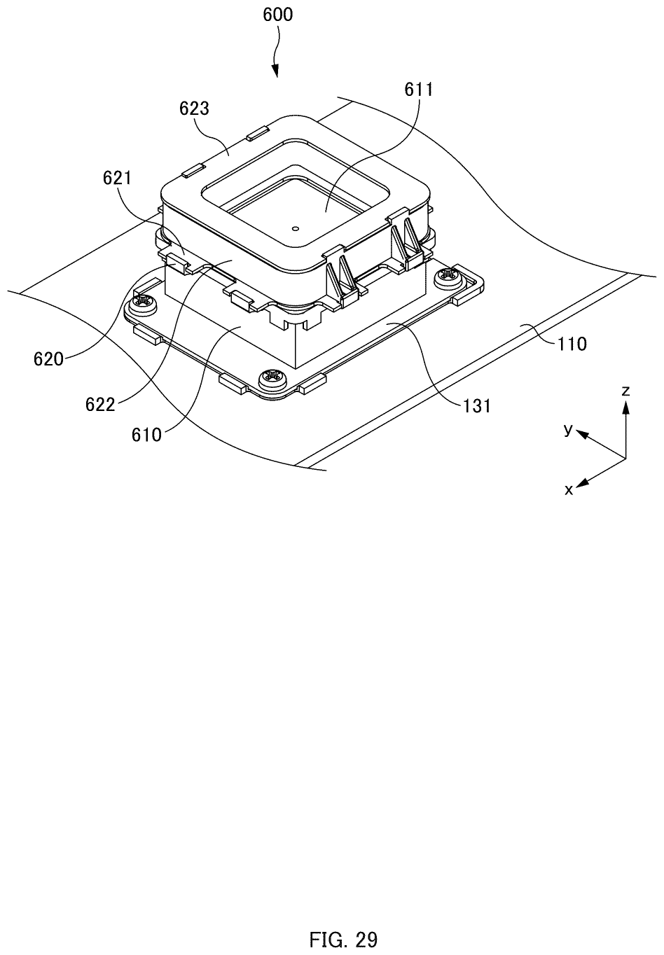

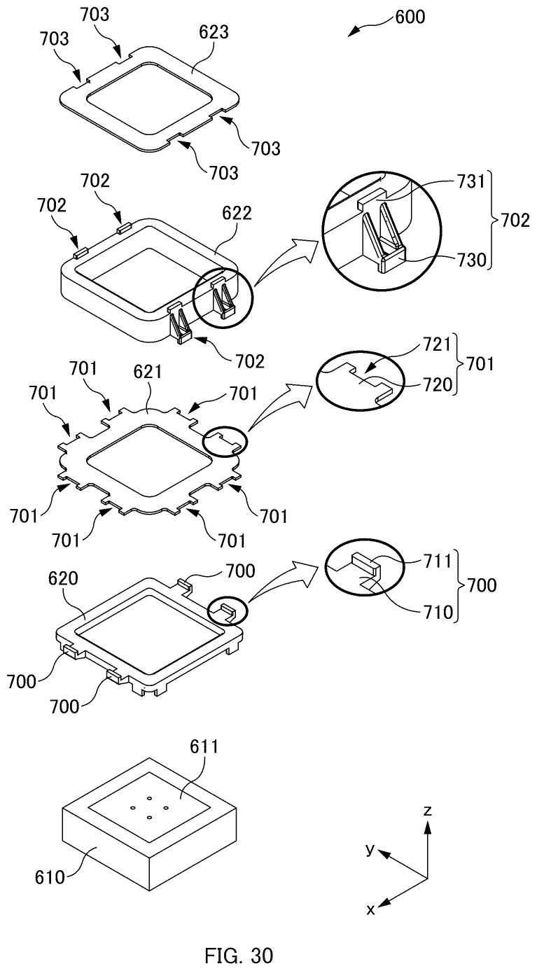

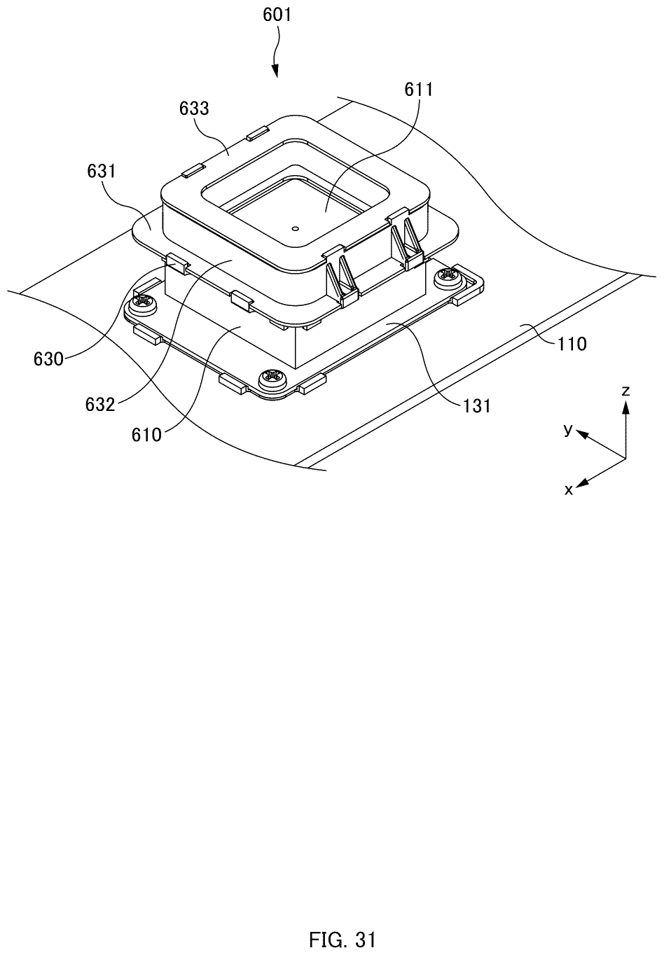

The patch antenna 600 is an antenna that supports radio waves in the L1 band and L5 band for GNSS, as in the patch antenna 127 illustrated in FIG. 12 and the like. FIG. 29 is an enlarged view of the patch antenna 600, and FIG. 30 is an exploded perspective view of the patch antenna 600.

The patch antenna 600, as with the patch antenna 127, is an antenna that includes two holding members and two metal bodies, and that can adjust the axial ratio while suppressing changes in the impedance. The patch antenna 600 includes a dielectric 610, a radiating element 611, holding members 620 and 622, and metal bodies 621 and 623.

Although not illustrated here, as in the patch antenna 127, in the patch antenna 600 as well, four feed lines 145 are respectively connected to four feed points of the radiating element 611. The dielectric 610 and the radiating element 611 in an embodiment of the present disclosure are the same as or similar to the dielectric 40 and the radiating element 41, respectively, and thus the holding members 620 and 622 and the metal bodies 621 and 623 will be described.

The holding member 620 made of resin is provided at the front surface of the dielectric 610 so as to surround the radiating element 611. The holding member 620 is a substantially square frame-shaped member to hold the metal body 621, and has an opening around the geometric center of the holding member 620.

Two projecting portions 700 are formed at each of two sides, parallel to the y-axis, of the front surface of the holding member 620. The projecting portions 700 each are a portion formed to fix the metal body 621 to the holding member 620 while determining the position of the metal body 621. The projecting portions 700 each include an extending portion 710 extending outward from the center of the holding member 620 and a protruding portion 711 extending in the +z direction from the end part of the extending portion 710.

The metal body 621 is a top plate to adjust the axial ratio of the patch antenna 600. The metal body 621 has a surrounding shape that surrounds the center of the radiating element 611, in plan view, when the metal body 621 is arranged at the holding member 620, and is integrally formed.

The metal body 621 of an embodiment of the present disclosure has a substantially square frame-shaped with an opening formed around the geometric center of the metal body 621, similarly to the holding member 620, which is a substantially square frame-shaped member. Two projecting portions 701 are formed at each of the four sides of the metal body 621.

The projecting portions 701 each include an extending portion 720 extending outward from the center of the metal body 621 and a recessed portion 721 formed at the end part of the extending portion 720. In an embodiment of the present disclosure, the metal body 621 is arranged at the front surface of the holding member 620 such that the projecting portions 711 of the holding member 620 are respectively fitted in the recessed portions 721 formed at the sides of the metal body 621 parallel to the y-axis.

In an embodiment of the present disclosure, when the holding member 620 and the metal body 621 are stacked on top of the dielectric 610, the metal body 621 is held such that the center of the dielectric 610 is aligned with the center of the opening formed in the metal body 621, in plan view. However, it is enough for the center of the dielectric 610 to fit within the opening of the metal body 621 to overlap, and thus the center of the dielectric 610 and the center of the metal body 621 do not have to be aligned with each other.

The holding member 622 is a frame-shaped member made of resin, and is provided at the front surface of the metal body 621 that is a first one. Two mounting portions 702 are formed at each of two sides, parallel to the x-axis, of the holding member 622.

The mounting portions 702 each are a portion to determine the position of the metal body 623 relative to the holding member 622, while mounting the metal body 621 to the holding member 622. The mounting portions 702 each include a protruding portion 730 formed on the lower side of a portion protruding from a side surface located in the y direction of the holding member 622, and a protruding portion 731 formed at the front surface of the holding member 622. The protruding portion 730 is formed so as to extend in the −z direction at the end part on the lower side of the portion protruding from the side surface located in the y direction, and the protruding portion 731 is formed so as to extend in the +z direction.

In an embodiment of the present disclosure, for example, the shape of the protruding portions 730 is designed such that the four protruding portions 730 are respectively aligned with the four recessed portions 721 at the sides parallel to the x-axis of the metal body 621, in plan view, when the holding member 622 is provided to the front surface of the metal body 621.

As a result, when the holding member 622 is stacked on the metal body 621, the four protruding portions 730 are respectively fitted in the four recessed portions 721 at the sides parallel to the x-axis of the metal body 621.

The metal body 623 is, as with the metal body 621, a surrounding-shaped member (top plate), and two recessed portions 703 are formed at each of the sides parallel to the x-axis thereof. In an embodiment of the present disclosure, the metal body 623 is arranged at the front surface of the holding member 622 in a state where the four protruding portions 731 of the holding member 622 are respectively fitted in the four recessed portions 703 of the metal body 623.

Here, the length of the four sides of the metal body 623 is substantially equal to the length of the four sides of the metal body 621. Furthermore, the width of the sides of the metal body 623 when the recessed portions 703 are ignored is substantially equal to the width of the sides of the metal body 621 when the projecting portions 701 are ignored. Accordingly, when the projecting portions 701 and the recessed portions 703 are ignored, the metal body 621 and the metal body 623 have substantially the same shape in plan view.

Further, in the patch antenna 600, as with the patch antenna 127, the metal bodies 621 and 623 are held such that the center of the radiating element 611, the center of the metal body 621, and the center of the metal body 623 are all aligned with one another. Further, in the patch antenna 600, the positional relationship among the radiating element 611 and the metal bodies 621 and 623 in plan view is the same as or similar to the positional relationship among the radiating element 41 and the metal bodies 46 and 48 of the patch antenna 127 in plan view. Accordingly, in the patch antenna 600, the centers of the substantially square radiating element 611 and the metal bodies 621 and 623 (that is, the centers of the openings of the metal bodies 621 and 623) are all substantially aligned with one another, thereby being able to further improve the axial ratio.

In such a configuration, it is possible to downsize the patch antenna 600 more than, for example, the case where the centers of the radiating element 611 and the metal bodies 621 and 623 are out of alignment.

Further, in the patch antenna 600, there are four parts at which the metal body 621 is fixed to the holding member 620 (that is, the protruding portions 711 and the recessed portions 721), and there are also four parts at which the holding member 622 is fixed to the metal body 621 (that is, the recessed portions 721 and the protruding portions 730). Furthermore, there are four parts at which the metal body 623 is fixed to the holding member 622 (that is, the protruding portions 731 and the recessed portions 703). Accordingly, in the patch antenna 600, the holding members 620 and 622 and the metal bodies 621 and 623 are fixed more firmly.

However, the number of the parts at which the metal body 621 is fixed to the holding member 620 and the number of parts at which the metal body 23 is fixed to the holding member 622 are not limited to four, and such a fixing part does not have to be located at each of the sides. For example, the fixing part may be provided at one location at each of a pair of opposing sides, it may be provided at one location at each of the sides, or it may be provided at multiple locations.

In the vehicular antenna device 17, as in other embodiments, the patch antenna 600 can adjust the axial ratio while suppressing change in the impedance.

### Vehicular Antenna Device 18 (Seventh Embodiment)

FIG. 28 is a diagram illustrating a configuration of the vehicular antenna device 18 of an embodiment of the present disclosure. When comparing between the vehicular antenna device 18 and the vehicular antenna device 17, the configurations are the same except for a patch antenna 601. Thus, the patch antenna 601 will be described here.

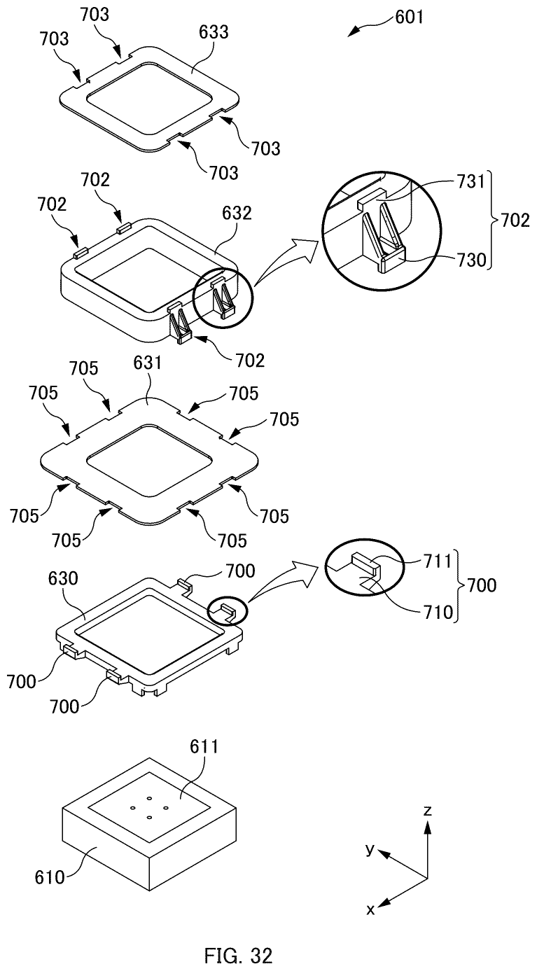

FIG. 31 is an enlarged view of the patch antenna 601, and FIG. 32 is an exploded perspective view of the patch antenna 601. As with the patch antenna 600, the patch antenna 601 is an antenna that supports radio waves in the L1 band and L5 band for GNSS.

The patch antenna 601 includes the dielectric 610, the radiating element 611, holding members 630 and 632, and metal bodies 631 and 633. The holding members 630 and 632 and the metal body 633 are the same as or similar to the holding members 620 and 622 and the metal body 623 of the patch antenna 600, respectively. Thus, the metal body 631 will be mainly described here.

The metal body 631 is, as with the metal body 621, a top plate to adjust the axial ratio of the patch antenna 600. When being arranged at the holding member 630, the metal body 631 has a surrounding shape that surrounds the center of the radiating element 611 in plan view, and is integrally formed.

As with the holding member 630, which is a substantially square frame-shaped member, the metal body 631 has a substantially square frame shape with an opening formed around the geometric center of the metal body 631. Here, the length of the four sides of the metal body 631 is larger than the length of the four sides of the metal body 633. Further, the width of the sides of the metal body 631 when the recessed portions 705 are ignored is larger than the width of the sides of the metal body 633 when the recessed portions 703 are ignored. Accordingly, the area of the metal body 631 in the first stage in plan view is larger than the area of the metal body 633 in the second stage.

Two recessed portions 705 are formed at each of the four sides of the metal body 631. In an embodiment of the present disclosure, the metal body 631 is arranged at the front surface of the holding member 630, in a state where the four protruding portions 711 of the holding member 630 are respectively fitted in the four recessed portions 705 formed at two sides parallel to the y-axis of the metal body 631.

Further, the holding member 632 is arranged at the front surface of the metal body 631, in a state where the four protruding portions 730 of the holding member 632 are respectively fitted in the four recessed portion 705 formed at two sides parallel to the x-axis of the metal body 631. Accordingly, in the patch antenna 601, the metal body 631 is firmly fixed to the holding member 630, and the holding member 632 is firmly fixed to the metal body 631.

The positional relationship among the radiating element 611 and the metal bodies 631 and 633 of the patch antenna 601 in plan view is the same as or similar to the positional relationship among the radiating element 41 and the metal bodies 46 and 48 of the patch antenna 127 in plan view. Accordingly, even with such a configuration, the patch antenna 601 can adjust the axis ratio while suppressing change in the impedance.

### Vehicular Antenna Device 19 (Eighth Embodiment)

FIG. 28 is a diagram illustrating a configuration of the vehicular antenna device 19 of an embodiment of the present disclosure. When comparing between the vehicular antenna device 19 and the vehicular antenna device 17, the configurations are the same except for the patch antenna 602. Thus, the patch antenna 602 will be described here.

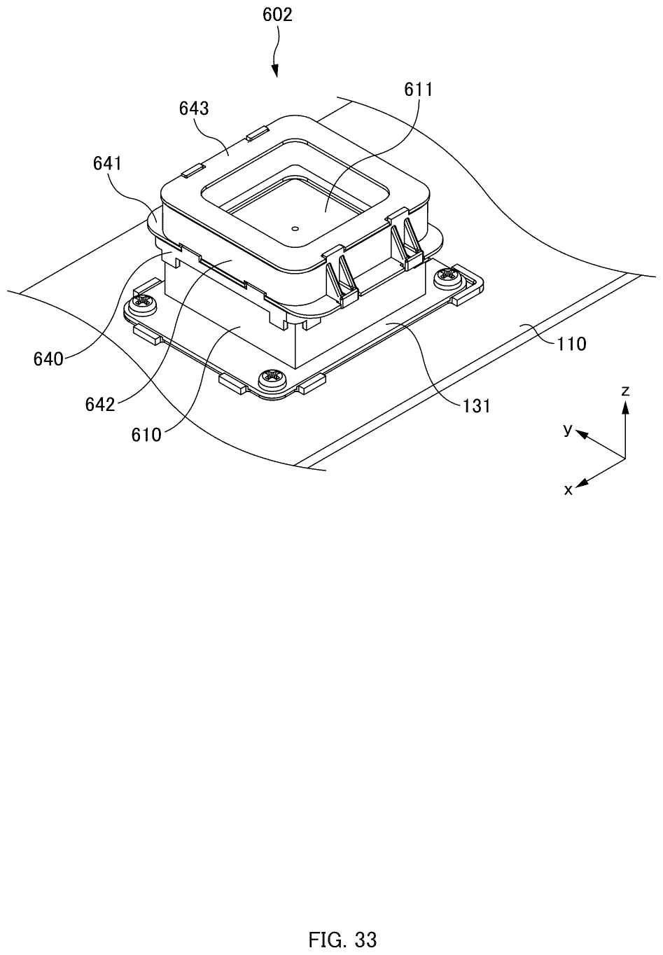

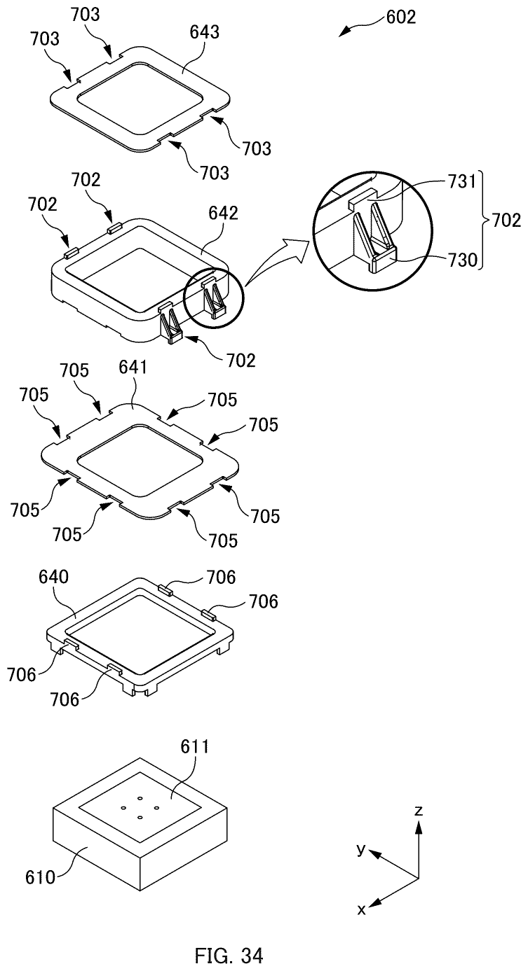

FIG. 33 is an enlarged view of the patch antenna 602, and FIG. 34 is an exploded perspective view of the patch antenna 602. The patch antenna 602 is, as with the patch antenna 600, an antenna that supports radio waves in the L1 band and L5 band for GNSS.

The patch antenna 602 includes the dielectric 610, the radiating element 611, holding members 640 and 642, and metal bodies 641 and 643. The holding member 642 and the metal body 643 are the same as or similar to the holding member 622 and the metal body 623 of the patch antenna 600, respectively. Thus, the holding member 640 and the metal body 631 will be mainly described here.

The holding member 640 is a substantially square frame-shaped member to hold the metal body 641, and has an opening around the geometric center of the holding member 640. In an embodiment of the present disclosure, the holding member 640 is provided at the front surface of the dielectric 610 so as to surround the radiating element 611.

Two protruding portions 706 are formed at each of two sides, parallel to the y-axis, of the front surface of the holding member 640. The protruding portions 706 each are a portion formed to fix the metal body 641 to the holding member 640 while determining the position of the metal body 641.

The metal body 641 is, as with the metal body 621, a top plate to adjust the axial ratio of the patch antenna 600. When being arranged at the holding member 630, the metal body 641 has a surrounding shape that surrounds the center of the radiating element 611 in plan view, and is integrally formed.

The metal body 641 has a substantially rectangular frame shape with an opening formed around the geometric center of the metal body 631. The two recessed portions 705 are formed at each of the four sides of the metal body 641. In an embodiment of the present disclosure, the two sides parallel to the y-axis, of the four sides of the metal body 641, are longer than the two sides parallel to the x-axis thereof. Furthermore, in the metal body 641, when the recessed portions 705 are ignored, the width of the sides parallel to the x-axis is larger than the width of the sides parallel to the y-axis.

The metal body 643 has a substantially rectangular frame shape, and the length of each side is substantially equal to the length of the sides parallel to the x-axis of the metal body 641. Further, when the recessed portions 703 are ignored, the width of the sides in the metal body 643 is substantially equal to the width of the sides parallel to the y-axis when the recessed portions 705 are ignored in the metal body 641. Accordingly, in the patch antenna 601, the metal body 631 in the first stage is larger than the metal body 633 in the second stage.

In an embodiment of the present disclosure, the metal body 631 is arranged at the front surface of the holding member 630, in a state where the four protruding portions 706 of the holding member 640 are respectively fitted in the four recessed portions 705 formed at two sides parallel to the y-axis of the metal body 641.

Further, the holding member 642 is arranged at the front surface of the metal body 641 in a state where the four protruding portions 730 of the holding member 642 are fitted in the four recessed portions 705 formed at two sides parallel to the x-axis of the metal body 641. Accordingly, in the patch antenna 602, the metal body 641 is firmly fixed to the holding member 640, and the holding member 642 is firmly fixed to the metal body 641.

The positional relationship among the radiating element 611 and the metal bodies 641 and 643 of the patch antenna 602 in plan view is the same as or similar to the positional relationship among the radiating element 41 and the metal bodies 46 and 48 of the patch antenna 127 in plan view. Accordingly, even with such a configuration, the patch antenna 602 can adjust the axial ratio while suppressing change in the impedance.

Each of the metal bodies 621, 631, and 641 corresponds to a “first metal body”, and each of the metal bodies 623, 633, and 643 corresponds to a “second metal body”.

### Summary

The vehicular antenna device according to an embodiment of the present disclosure has been described above. For example, in the patch antenna 35 illustrated in FIGS. 3 to 5, the dielectric 40 is located on the back side (one surface side) of the radiating element 41. The metal body 46 (first metal body) is provided on the front surface side (side opposite to the one surface side) of the radiating element 41, the metal body 46 being located at a position corresponding to the wave source of the radiating element 41.

The metal body 46 and the center of the radiating element 41 are non-overlapping in plan view. Accordingly, with the patch antenna 35 as such, it is possible to reduce change in the impedance of the patch antenna 35, as compared with the case without the metal body 46.

Further, as illustrated in FIG. 6, for example, the metal body 46 has a surrounding shape that surrounds the center of the radiating element 41. Thus, it is possible to appropriately arrange the metal body 46 at a position corresponding to the wave source of the radiating element 41 (a position at which the intensity of radio waves is strong), while reducing the parasitic capacitance between the metal body 46 and the radiating element 41.

Further, for example, as illustrated in FIG. 6, the metal body 46 has an overlapping region in which the metal body 46 overlaps the radiating element 41 in plan view. By having such an overlapping region, the metal body 46 can appropriately function as a so-called top plate.

In an embodiment of the present disclosure, the distance D2 between the front surface of the radiating element 41 and the back surface of the metal body 46 is set such that the above two are capacitively coupled. Accordingly, the metal body 46 can appropriately function as a so-called top plate.

Further, for example, as illustrated in FIG. 6, the metal body 46 and the slot 70 of the radiating element 41 are non-overlapping in plan view. Accordingly, in an embodiment of the present disclosure, it is possible to prevent increase in the parasitic capacitance between the radiating element 41 and the metal body 46.

Further, for example, as illustrated in FIG. 5, the metal body 46 is held by the holding member 45. With such a configuration, the locations of the radiating element 41 and the metal body 46 can be determined with high precision.

Further, as illustrated in FIG. 13, for example, the patch antenna 127 further includes the metal body 48 above the metal body 46. That is, the metal body 46 (first metal body) is provided between the radiating element 41 and the metal body 48 (second metal body). With the patch antenna 127 including two metal bodies as such, it is possible to adjust the axial ratio of the patch antenna 127.

Further, for example, the metal body 48 may have a shape different from that of the metal body 46 (for example, a substantially square plate as in the metal body 42). However, with the metal body 48 having a surrounding shape that is the same as or similar to that of the metal body 46, the parasitic capacitance of the patch antenna 127 can be further reduced.

Further, as illustrated in FIG. 3, for example, the vehicular antenna device 11 includes the patch antenna 35 that supports a GNSS frequency band (first frequency band) and the antenna 32 that supports an AM/FM frequency band (second frequency band). In such a case, the axial ratio of the patch antenna 35 may be affected by the antenna 32.

However, in an embodiment of the present disclosure, the patch antenna 35 includes the metal body 46 capable of adjusting the axial ratio while suppressing change in the impedance of the patch antenna 35. Accordingly, even when the patch antenna 35 is provided to a composite antenna device that includes multiple antennas, the patch antenna 35 can be operated with a desired frequency.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

An antenna device according to an embodiment of the present disclosure includes one to be brought into a vehicle and used in the vehicle, in addition to one mounted to a vehicle. Further, it is assumed that an antenna device according to an embodiment of the present disclosure is used for a “vehicle” that is a wheeled vehicle, however, it is not limited thereto and, for example, it may be used for a movable body such as a flight vehicle including a drone and the like, a probe vehicle, a construction machinery, an agricultural machinery, a vessel, and the like without wheels.

### Reference Signs List

10-16 vehicular antenna device

20, 100 antenna base

22 case

30, 35, 125, 127, 129, 402, 411, 422, 432, 442, 502, 600-602 patch antenna

31-33, 120, 126, 128, 200 antenna

40, 310, 311, 550, 610 dielectric

41, 51, 92, 320, 321, 350, 611 radiating element

42, 46, 48, 49, 91, 96, 140, 621, 623, 631, 633, 641, 643 metal body

45, 47, 620, 622, 630, 632, 640, 642 holding member

60,145 feed line

70 slot

71, 75 feed point

90 metal plate

93, 94 metal pattern

95 opening

110, 400, 420, 430, 440, 500 metal base

121, 122 parasitic element

160 holder

300 main body portion

361 feeding point

410, 421 metal plate

431, 441 resin base

510, 511 feed line

520-524 screw

530 opening

570 space

580-584 support portion

590 shield member

1. A patch antenna comprising:
a radiating element;
a dielectric located on one surface side of the radiating element; and
a first metal body located on a side opposite to the one surface side of the radiating element, the first metal body being located so as to correspond to a wave source of the radiating element, wherein
the radiating element is located between the dielectric and the first metal body, and
the first metal body and a center of the radiating element are non-overlapping in plan view, the plan view being a view in a direction perpendicular to the one surface of the radiating element.

2. The patch antenna according to claim 1, wherein
the first metal body has a surrounding shape that surrounds the center of the radiating element in the plan view.

3. The patch antenna according to claim 1, wherein
the first metal body has an overlapping region in which the first metal body overlaps the radiating element in the plan view.

4. The patch antenna according to claim 1, wherein
the first metal body and the radiating element are electrically coupled.

5. The patch antenna according to claim 1, wherein
the radiating element has at least one opening,
the first metal body and the opening are non-overlapping in the plan view.

6. The patch antenna according to claim 1, further comprising
a first holding member to hold the first metal body.

7. The patch antenna according to claim 1, further comprising
a second metal body, wherein
the first metal body is located between the radiating element and the second metal body.

8. The patch antenna according to claim 7, wherein
the second metal body has a surrounding shape that surrounds the center of the radiating element in the plan view.

9. An antenna device comprising:
a case;
a base and the case form a housing space;
a patch antenna housed in the housing space, the patch antenna supporting radio waves in a first frequency band; and
at least one antenna that supports radio waves in a second frequency band different from the first frequency band, wherein
the patch antenna includes
a dielectric,
a radiating element located on an upper surface side of the dielectric; and
a first metal body located above a wave source of the radiating element, wherein
the first metal body and a center of the radiating element are non-overlapping in a plan view, the plan view being a view in a direction perpendicular to an upper surface of the radiating element, and
the first metal body and the radiating element are electrically coupled.
